(19) United States
(12) Patent Application Publication
(10) Pub. No.: US 2010/0276591 A1
(43) Pub. Date: Nov. 4, 2010

(54) Electrode Structures

(75) Inventor: Alan Finlay, Richmond (GB)

Correspondence Address: BISHOP & DIEHL, LTD., 1320 TOWER ROAD, SCHAUMBURG, IL, 60173, US

(73) Assignee: Microsaic Systems Limited, Woking (GB)

(21) Appl. No.: 12/837,122

(22) Filed: Jul. 15, 2010

Related U.S. Application Data
(63) Continuation of application No. 12/291,266, filed on Nov. 7, 2008.

(30) Foreign Application Priority Data
Nov. 9, 2007 (GB) GB0722038.7

(51) Int. Cl. H01J 49/42; H01J 3/00; H01J 49/02; H01J 1/88; H05B 41/14

(52) U.S. Cl. 250/292; 250/489; 250/505.1; 313/292; 315/246

(57) ABSTRACT

This invention describes an electrode structure formed from a plurality of individual electrodes, the individual electrodes being provided on separate submounts, the submounts being coupled to one another using kinematic ball mounts. Such a structure may be configured as a RF ion guide, mass filter or ion trap.

### CROSS-REFERENCE TO RELATED APPLICATIONS

This application is a continuation of U.S. patent application Ser. No. 12/291,266 filed on Nov. 7, 2008, which claims priority to United Kingdom Application GB0722038.7, filed Nov. 9, 2007, wherein both applications are hereby incorporated by reference.

### TECHNICAL FIELD OF THE INVENTION

The invention relates to electrode structures for use with charged particle beams. In particular, the invention provides for electrode structures that in various configurations act as an ion trap, ion guide, ion lens, collision cell or mass analyser to trap, transfer, collide, collimate, focus, analyse or filter a beam of ions. The electrode structure may be used to trap, guide or filter ions of interest, generated from a molecular beam, for analysis by their mass to charge ratio in an analytical instrument such as a mass spectrometer detector.

### BACKGROUND OF THE INVENTION

Mass spectrometry (MS) is a powerful analytical technique that is used for the qualitative and quantitative identification of organic molecules, peptides, proteins and nucleic acids. MS offers speed, accuracy and high sensitivity. Key components of a mass spectrometer are the ion source, ion coupling optics, mass analyser and detector. The ion source transforms analyte molecules into a stream of charged particles, or ions, through a process of electron addition or subtraction. The ions can be ‘steered’ using electric or magnetic fields. Ion coupling optics or lenses collimate the ion flux from the ion source into the mass analyser. The analyser separates ions by their mass to charge ratio. Several different kinds of mass analyser are known in the art, including, but not limited to; magnetic sector, quadrupole, ion trap, time of flight and cycloidal. The ions exit the analyser in order of mass to charge ratio and in so doing produces a mass spectrum which is a unique signature or ‘fingerprint’ for the analyte. Ions are directed to a detector where they impact and discharge an ion current which may be counted and amplified by signal electronics before being displayed on a computer screen as a mass spectrum. The detector is normally an electron multiplier. These components together form the analytical sub-system of the mass spectrometer system.

Other mass spectrometer system components include vacuum pumps, a vacuum chamber, drive electronics, data acquisition electronics, power supplies and enclosures.

The mass analyser, or mass filter, as the name implies allows an ion of a chosen mass to charge ratio (m/z) to pass through while rejecting all the others. The possibility of using an electrodynamic quadrupole field was first proposed by Wolfgang Paul at the University of Bonn in the 1950s. This research culminated in a seminal paper by Paul in 1958, and in a basic U.S. Pat. No. 2,939,952. The advantages of the quadrupole as a mass analyser include its compactness, mechanical simplicity and sensitivity.

Several types of mass analysers have been developed which utilise electrodynamic quadrupole fields; the quadrupole mass filter, the monopole and the quadrupole ion trap (i.e. the “Paul Trap”). Various other mass analyser geometries that approximate to the quadrupole field have been proposed, including mass filters making use of square rather than cylindrical rods, quadrupole mass analysers driven with square waves rather than sinusoidal waves, cylindrical ion traps, linear ion traps based on the classic quadrupole geometry, so-called rectilinear ion traps using flat plate electrodes, linear ion traps based on segmented quadrupole rods, ‘toroidal’ ion traps wherein a Paul trap is turned into a torus, and so on. However, all of these geometries have it in common that they are used to generate quadrupole electrodynamic fields to trap or filter ions. A major contribution in 1960s was made by Brubaker by providing a pre-filter to provide a delay in the DC ramp, and thereby effecting enhanced sensitivity and resolution in the quadrupole mass filter. A number of more exotic quadrupole-like geometries have been proposed including the monopole, the quadrupole monopole, the use of a spherical retarding-field electrode at the exit of the quadrupole filter to enhance resolution at high mass, a four-fold monopole with a central round rod inside a housing with a square cross section, a ‘solenoid’ mass filter and a static twisted quadrupole.

Until recently, the mass analyser components that are used to generate an electrodynamic quadrupole field have been manufactured from materials like steel and ceramic using conventional “machine shop” processes such as milling, turning, grinding, lapping and polishing. These manufacturing processes and materials are still the mainstay of the mass spectrometer industry and are the basis of almost all products on the market that make use of the quadrupole electrodynamic field principle such as; the hyperbolic ion trap or ‘Quisitor’ (i.e. ‘quadrupole ion store’), the cylindrical ion trap, the orbitrap and ion guides like hexapoles and octopoles. Conventional mass spectrometer components like these are manufactured and assembled using machine tools and other workshop practices. Because mechanical precision is critical to the final performance of the mass spectrometer, these parts are fixed in place and assembled by a trained technician using precise, proprietary tooling.

In U.S. Pat. No. 6,683,301 B2 [Whitehouse et al.], an electrostatic potential is applied to counter electrode positioned above or across from a surface or array of RF electrodes. The counter electrode has an electrostatic potential applied to it which drives ions between the counter electrode and the RF surface towards or away from the RF surface. Ions approaching the RF surface are prevented from hitting the RF electrodes by the repelling pseudopotential field generated by the RF voltage applied the RF electrodes. In US2005/0258364A1 [Whitehouse et al.] a RF surface electrode array is disclosed that has, addition to the counter electrode of U.S. Pat. No. 6,683,301, DC electrodes positioned behind (the “back electrodes”) and on the sides (the “side electrodes”) of the RF surface electrode array. In accordance with US2005/0258364A1, these DC back and side electrodes may be used to control ions in the pseudopotential field between the RF surface electrode array and the counter-electrode. The RF surface electrode array may be made up of an array of spherical electrodes. The RF voltage applied to the RF surface electrodes can be combined with the electrostatic potentials applied the back and side electrodes to control the movement of ions in the pseudopotential field region above the RF electrode array. The main objective of US2005/0258364A1 is to provide a ‘pusher’ electrode in a Time of Flight (TOF) mass spectrometer. This pusher electrode array is intended to be used to generate a ‘pulsed’ packet of ions down the flight tube of the TOF.

It should be noted that U.S. Pat. No. 6,683,301 and US2005/0258364A1 both disclose a RF surface, which can be an array of electrodes, that has a counter electrode positioned opposite, and also behind and around, the RF surface. By applying an electrostatic potential to the counter electrode and a RF voltage to the RF surface, a pseudopotential field may be generated between the counter electrode and the RF surface that traps ions. However, both U.S. Pat. No. 6,683,301 and US2005/0258364A1 rely on DC counter electrodes (i.e. across, behind or to the sides) in cooperation with a RF surface (or RF electrode array) to trap or guide ions.

Several attempts have been made to miniaturise and integrate quadrupole mass analysers using micromachining techniques, or using semiconductor microfabrication processes and micro-electromechanical systems (MEMS) technology, some of which are described in our previously filed British applications, GB 0202665.6 and GB 0217815.0. An example of a miniature quadrupole mass filter is described in our application, GB 0403122.5.

The principal advantages of miniaturised mass analysers are the significantly reduced system requirements, in particular smaller power supplies, electronics and vacuum systems. This dividend is a consequence of the scaling laws associated with geometrically reduced electrical fields, and the shorter mean free path between collisions of molecules. In this way, a miniaturised mass analyser permits the development of mass spectrometer detector systems that are highly deployable, and may be configured for applications and markets that heretofore were not addressed. Examples of these applications include the use of hand-portable mass spectrometer detectors for the detection of explosives, hazardous chemicals and pollutants in the field, or on-line monitoring of reaction processes in the petrochemical industry.

For a miniaturised, or portable, mass spectrometer to be commercially viable, it must achieve the performance required of it by the application. Unless the mass spectrometer detector has acceptable resolution, mass range and sensitivity, it will fail to detect the chemical species of interest with any degree of accuracy. For example, in some applications (in particular explosives detection) sensitivity is particularly valued. The success or failure of a mass spectrometer instrument in these markets will be determined in great part by its performance, and not just by ergonomic factors such as detector size, weight and power consumption. The performance of the mass spectrometer system is determined by the characteristics of the mass analyser used. Therefore, efficient mass analysers are required which can at once combine the benefits of the scaling laws associated with miniaturisation of the analyser, such as smaller power supplies and vacuum pumps, with the raw performance of large, conventionally manufactured mass analysers.

To date, a number of miniaturised mass spectrometer systems have been demonstrated, and a subset of these have been marketed and sold. However, none of the commercially available portable mass spectrometer systems approaches the resolution, sensitivity or mass range of large, conventional tenchtop' mass spectrometer systems. Typical resolution of the commercially available, portable mass spectrometers is limited to a peak width of approximately 1.0 amu across a mass range of 1-450 m/z, and sensitivity (without the aid of a pre-concentrator) of mid to low parts per billion. The goal of this invention is to provide a mass analyser that substantially enhances the performance of a miniaturised mass spectrometer, in particular its resolution and sensitivity, while maintaining the system advantages arising from physical scaling laws such as the relationship between the mean free path and the operating pressure of the mass analyser.

There is therefore a need to provide an improved mass analyser that overcomes these and other disadvantages associated with the prior art.

### SUMMARY OF THE INVENTION

These and other problems are addressed by the present invention in providing an electrode cell formed from a plurality of individual electrodes arranged relative to one another to define a three dimensional geometric structure having individual ones of the plurality of electrodes located at each of the vertices of the geometric structure and wherein each of the electrodes of the cell present a curved surface to each other electrode of the cell. One or more of these electrode cells may be configured to act as a mass filters, ion guides or ion traps.

The electrodes may be formed having only curved surfaces and may be fabricated in geometries such as those defined by spheroids, hyperboloids and/or super ellipsoids. Within the context of the present invention the term spheroid means is a quadric surface in three dimensions obtained by rotating an ellipse about one of its principal axes.

Electrodes formed in accordance with the teaching of the present invention will have a conducting surface but could be a fabricated in a solid piece or for example could be fabricated having two or more constituents, the outer constituent or layer being formed from a conducting material such as a metal. Examples of such a latter arrangement may include metal coated insulated substrates such as glass or ceramic. A further modification to an electrode structure could be provided by fabricating the electrode from a structure having a conducting surface encapsulating a hollow core. Electrodes formed in accordance with the teaching of the present invention could also be formed from a conductive composite material.

It will be understood that by defining a three dimensional geometric structure that the individual electrodes of the cell are separated from other electrodes of the cell in three dimensions, i.e. the X, Y and Z direction.

In a simplest configuration the cell may be fabricated in a cube geometry having eight corners, each of the corners equidistant from a mid point of the cell, the distance between neighbouring corners also being equal. In such an arrangement the cell includes 8 electrodes, one provided at each corner of the cubic structure.

It will be understood that in a cubic structure the distances between each of the neighbouring electrodes is equal. It is not intended to limit the teaching of the present invention to such a specific geometrical structure in that the distances between adjacent or neighbouring electrodes may be different. In such latter examples it will be understood that a plurality of different geometrical configurations may be defined by the relative orientation of the individual ones of the plurality of electrodes relative to one another.

The invention also provides an electrode matrix formed by combining two or more individual electrode cells. In this context the cell may be considered as a constituent building block of the matrix. It will be understood that certain matrix structures may benefit from using the same building block cells whereas other matrix structure may utilise cells of different geometries. When multiple building blocks are combined, it will be understood that adjacent cells may share the same side walls, in that the electrodes forming the vertices or corners of a first cell may also be considered as forming the vertices or corners of a second neighbouring cell. As the curved surfaces of the electrodes are desirably symmetrical in a three dimensions it will be understood that field lines generated in a first direction from an individual electrode will be equivalent to field lines generated in a second opposing direction.

By providing the individual electrodes in a spheroid geometry located at each of the corners of the cells it will be understood that they present curved surfaces to each of the neighbouring electrodes. If the electrodes are substantially identical, then the field lines that are generated by each of the electrodes will be equal allowing the generation of a pseudopotential well which may be used to filter, trap or guide ions or other charged particles. In an exemplary arrangement the spheroid shape is generated through a circular ellipse such that the resultant electrode is spherical in shape. In this way the electrode cell will be formed from a plurality of spherical electrodes each being centred on the corners of the cells. By applying suitable potential and frequency to the individual ones of the electrodes defining the corners of the cell or indeed by switching the phase of the RF potential applied to each electrode, it is possible to change the velocity of a charged particle and control its trajectory. It will be understood that in this usage, that the term velocity is considered a vector physical quantity, having both speed and direction components.

A cell or matrix arrangement provided in accordance with the teaching of the invention may be considered useful in the fabrication of a number of different structures. As was mentioned above, useful applications include filters, traps or ion guides. It will be understood that quadrupole mass filters are commonly an arrangement of four rods in parallel. In such an arrangement, the rods are typically cylindrical electrodes, or four rod electrodes having a hyperbolic surface facing each other, or more unusually four square rods or four flat plates. By applying equal RF voltages out of phase to diagonally opposed pairs of rods, equipotential field lines are generated between the rods which can be represented by sets of hyperbolae in the x-y plane with a geometrically four-fold symmetry about the z axis. A charged particle, or more conventionally an ion, will have a stable trajectory down the centre of the quadrupole, the trajectory describing a spiral around the z axis. In the context of the present invention the x-y plane the quadrupole may be represented by four circles of radius r, i.e. spheroids where the generating ellipse is a circle, organised symmetrically at the corners of square, such that all four circles are equidistant. A circle of radius r₀ touching all four circles can be drawn in the centre of the square.

This x-y plane is a cross section of the quadrupole's four rods which are parallel to the z axis. Each of the diagonally opposite pairs of rods is connected to a RF supply so that the two pairs are out of phase. The rods form an electric multipole, so that ions travelling down the centre of the quadrupole are simultaneously attracted and repelled by oppositely charged rod pairs. The polarity of the rod pairs changes with each cycle of the RF power, so that the ion is attracted and repelled between alternate pairs of rods. In this way the ion describes a stable trajectory between the rods.

A second cross section of the quadrupole rods in the x-y plane may be taken at a point further along the z axis. This point may a distance along the z axis that is equal to the length of one side of a square drawn orthogonally to the z axis between the centrelines of the rods, the centrelines of the rods orthogonally intersecting each corner of the square. These two squares may be joined by lines, parallel to the centrelines of the rods. These connecting lines are therefore equal in length to the sides of the two squares, and together the squares and lines form a cube, which may be considered an electrode cell. Alternatively, if the second cross section is taken at distance along the z axis which is not equal to the length of one side of the square connecting the centrelines of the rods, then together the squares and lines connecting the squares form a cuboid, which again could be considered an electrode cell as formed in accordance with the teaching of the present invention.

At each corner of this cube the rods' cross sectional area may be represented by discs or elliptical (or in the case where the rods have hyperbolic surfaces facing each other, the cross sections are super-elliptical) surfaces drawn in the x-y plane. The quadrupole rods may now be abstractly represented by a cube with a disc at each of its vertices. Four axes may be parallel to they axis, and down four sides of this cube. Each axis intersects the centres of two discs symmetrically. By rotating two of the discs around their common, intersecting axis, two spherical volumes of rotation may be generated. Repeating this for each of the four axes, eight spherical volumes of rotation may be generated, the centre points of which intersect each of the vertices of the cube. In this way an electrode structure cell of eight sphere electrodes of equal volume at each of the vertices of a cube may be constructed. Alternatively, if as a starting point cross sections are taken from quadrupole rods with hyperbolic surfaces, then volumes of rotation of these cross sections around intersection axes of rotation will generate superellipsoids, or superellipsoidal electrodes at each of the vertices of the cube, or cuboid. Similarly, if the quadrupole is constructed from rods with elliptical cross sections then ellipsoids, or ellipsoidal electrodes, may be generated at each of the vertices of the cube, or cuboid. Likewise if the rod surfaces are parabolic then paraboloids, or paraboloidal electrodes, may be generated at the vertices, and so on.

Together, the spheroids (a category which inlcudes spheres, superellipsoids, ellipsoids and paraboloids) subtend an internal spherical volume which intersects the surfaces of each spheroid at a tangent. This internal spherical volume has a radius r_{S}, which although not the same as r₀, can be considered to be analogous. This region of the invention is enclosed by the electrode cell. By applying DC and RF voltages in various permutations to the electrodes at the vertices of the cube, the electrode cell, of this invention, various electrostatic and pseudopotential fields may be generated inside this spherical volume that will have the effect of filtering, guiding or trapping ions.

In the context of a cubic electrode cell, if each of the electrodes of the cell is connected to a RF voltage supply, such that each electrode is out of phase with the three electrodes immediately adjacent to it (i.e. the electrodes at each of three connected vertices), then six electrodynamic quadrupole fields may generated across each of the cube's faces. As the polarity of these multipoles is alternated by the AC or RF voltage applied to the electrodes, they form electrodynamic quadrupole fields. An ion approaching along an axis orthogonal to any of these six faces will have a stable trajectory as it nears the cube, and between these spheroids as it passes inside the cube or cuboid. In this configuration, each face of the cube forms an electric multipole. The electrode structure is in effect an ‘all-axis’ (or six-axis) ion guide. If the spheroid electrodes are wired up in this way, then each face of the cube forms a plane with an electrodynamic quadrupole field between the four spheroids at each corner of the face.

It should be noted that when operated in this mode, the electrode structure cell could function as a collision cell for use in a tandem mass spectrometer. ‘Parent’ ions exiting the first quadrupole mass filter enter the electrode structure collision cell along the x axis, and can be collided with reagent ions, or chemical reagents, entering the collision cell along the y and/or z axis. The ‘parent’ ions react with the reagent, and ‘product’ ions are produced which exit the collision cell and are further analysed in the second stage quadrupole mass filter of the tandem mass spectrometer.

Clearly, the electrode structure configured in this way can be multiplied in arrays along the x, y and z axes. Very large arrays of six-axis ion guides may be constructed by replicating the electrode cell structure in this way.

In one embodiment of arrays of the electrode structure, arrays may be configured as N×N, N×M or N×M×O ion guides (where N, M and O are the number of ion channels desired along the x, y and z axis respectively). A lattice or matrix of ion guides, which is analogous to ‘cross-connect’ switches used as components linking and routing fibreoptical and optoelectronic networks, may be constructed from an array of N, M and O electrode structures. This may have applications in mass spectrometry, particle physics and quantum computing.

In another embodiment, the electrode structure may be configured as an RF ion guide or mass filter. In this embodiment, two diagonally opposed pairs of electrodes are connected to an RF voltage supply in phase, with the other two diagonally opposed pairs of electrodes connected to the same RF voltage out of phase. In this way, the electrode structure can be operated as a pseudo quadrupole mass filter in all-pass, or RF only, mode.

By applying a DC voltage ramp to the RF voltage supplies to the four electrode pairs, the electrode structure can be operated as a quadrupole mass filter and will scan ions in order of mass to charge ratio as the DC voltage is ramped. However, a major difference is that in a quadrupole, the DC voltage may be applied only to all four rods, whereas the electrode cell structure of the present invention has the advantage that it may be applied to some subset of all the electrodes. In this way, the electrode structure may be configured to approximate to the performance of a quadrupole with segmented rods—in other words a pseudo-quadrupole mass filter. For example, successive grids of electrodes, or successive electrode structure cells of eight electrodes, could be set up alternately with RF-only, RF and DC and so on, thereby alternately passing, filtering, passing, filtering ions and so on. Another option is to operated the first ‘grid’ of four electrodes in RF-only mode, and apply RF and DC to the second set of electrodes, thereby effecting a delayed DC ramp of the kind described by Brubaker. This configuration would emulate the behaviour of a quadrupole mass filter with pre and post filters.

Therefore it can be see that a unique advantage of the invention is the inherent flexibility of the electrode cell structure, which may be repeated in along all axes serially and/or in parallel, permits many more modes of operation than a traditional quadrupole, segmented quadrupole or tandem quadrupole mass spectrometer.

In common with the ‘all-axis’ RF ion guide described above, or like the ‘ion lattice’ or ion ‘cross-connect’ also described above, in another embodiment the electrode structure cell may be repeated serially to create longer ion guides, quadrupole mass filters or pseudo-quadrupole mass filters. Similarly, the electrode structure cell may be repeated in parallel to create N parallel ion channels, N quadrupole mass filters or N pseudo-quadrupole mass filters. In this way the electrode structures may be configured to act as arrays of multiple, parallel quadrupole-like mass filters, or arrays of multiple parallel RF ion guides. By switching the electrical connectivity of the electrode structure, the direction of the stable ion trajectory through the electrode structure may be ‘switched’ by 90 degrees, so that the trajectory is now parallel to any of the x, y or z axes. A three dimensional array of electrode structure cells may be reconfigured in this way to ‘switch’ the direction of the stable ion trajectory, or to switch the direction of mass analysis through the array, so that it effectively operates as an N×N, N×M or N×M×O ion switch.

In a further embodiment, the electrode structure cell may be operated as an ion trap. If we return to the concept of the quadrupole mass filter operated as an RF ion guide (i.e. in RF-only mode with no ramp of DC voltage), let us imagine an ion with a stable trajectory along the z axis of the quadrupole mass filter. The ion passes through the quadrupole until it reaches a cube (or cuboid) region subtended at each the cube's vertices by eight circular rod cross-sections. Normally, the ion will pass through this cube region and exit at the ends of the rods to a detector, typically an electron multiplier. Let us now imagine this quadrupole mass filter is mounted on its side (i.e. the rods are parallel to the z-x plane) on a stationary turntable. After the ion has passed through the quadrupole aperture and as it is nearing the half way point of the quadrupole we switch on the turntable so that the quadrupole mass filter now rotates at some frequency ω. The quadrupole field is now rotating around the ion. This rotating field should have the effect of trapping the ion within a region intersected by the axis of rotation of the quadrupole mass filter.

If we again consider the cubical (or cuboidal) volume that is subtended between the electrodes (as described above), and which forms an exemplary electrode structure cell of the invention, by careful configuration of the electrical contacts to the electrodes, and the sequence with which the RF voltage phase is applied to the individual spheroid electrodes, we will see that the electrode structure can made to simulate the ‘spinning’ of a quadrupole mass filter around an axis of rotation intersecting the centre of the cubical volume. In once case, this ‘virtual’ axis of rotation may be orthogonal to the top face of the cube (i.e. along they axis). This axis of rotation may also be parallel to the x or z axes.

By applying RF voltage in phase to a set of two diagonally opposed pairs of electrodes parallel to the x axis, and by applying RF voltage out of phase to the other two diagonally opposed pairs, also parallel to the x axis, we can generate electrodynamic quadrupole fields between these pairs so that together these fields form a pseudopotential well through the electrode structure. Therefore, the electrode structure mimics the behaviour of a quadrupole operated in RF-only mode; in other words, when the quadrupole is functioning as an RF ion guide.

To ‘rotate’ this quadrupole RF ion guide counter-clockwise (for example) around they axis, we next disconnect the same RF voltage supply in phase from the first set of two pairs, and instead connect it to a second set of two diagonally opposed pairs of electrodes, this time parallel to the z axis. Out of phase RF voltage is connected to the other set of diagonally opposed pair of electrodes, also parallel to the z axis. The quadrupole operated as a RF ion guide has now ‘rotated’ 90 degrees.

If this sequence is repeated for the sets of electrode pairs parallel to the x axis, and thereafter to the electrode pairs parallel to the z axis and so on, this should has the effect of creating a rotating pseudopotential well within the electrode structure. This rotating pseudopotential well will act as an electrodynamic saddle point, trapping an ion within the electrode structure cell.

This pseudopotential well, or saddle point, may be visualised as the point of intersection of each of the electrodynamic quadrupole planes. These planes are formed at any instant between a set of four spheroid electrodes, made up of two pairs of diagonally opposed electrodes, connected up to reproduce the field across the cross section of a quadrupole mass filter operated in RF-only mode. The first diagonally opposed pair is electrically connected in phase to the RF voltage supply, and the second pair is connected out of phase, thereby forming an electrodynamic quadrupole field between the four electrodes. This electrodynamic quadrupole field can be thought of as a plane. By sequencing the connection of pairs parallel to the x axis and z axis, these field planes can be made to rotate around the y axis (or the x or z axis), thereby generating a stable, saddle point at the point of intersection of these planes.

These and other features and benefit will be understood with reference to the following exemplary embodiments.

### BRIEF DESCRIPTION OF THE DRAWINGS

FIG. 1 shows a cross section of a quadrupole mass filter.

FIG. 2 depicts the four cylindrical rods of a quadrupole mass filter, with a cross section, and diagonally opposed rod pairs connected to a RF voltage supply.

FIG. 3 shows a quadrupole mass filter with two cross sections.

FIG. 4 shows a quadrupole mass filter with a cube (or cuboid) formed by connecting two cross sections.

FIG. 5 shows a cube (or cuboid) formed by connecting two quadrupole cross sections.

FIG. 6 depicts a cube subtended between discs at each of its vertices, each disc representing a cross section of a quadrupole rod, the discs performing a volume of rotation around an axis to generate a cell electrode structure of eight spheres at the vertices.

FIG. 7 is a diagram showing a cell electrode structure of eight equidistant sphere electrodes at the vertices of the cube subtended between them.

FIG. 8 is depicts a cell electrode structure of eight equidistant spheroid electrodes with a sphere between them, the internal sphere tangentially intersecting the surfaces of the sphere electrodes.

FIG. 9 is a diagram of a cell electrode structure with spheroid electrodes connected to a RF voltage supply, in operation as an all-axis ion guide

FIG. 10 is a diagram of the electrode structure shown in FIG. 9 with the polarity reversed.

FIGS. 11 and 12 depict the cell electrode structure shown in FIGS. 9 and 10, with electrodynamic quadrupole fields represented by shaded surfaces.

FIG. 13A shows the cell electrode structure in operation as an ‘all-axis’ ion guide, with electrodynamic quadrupole fields depicted as shaded surfaces between eight spheroid electrodes of alternate polarities. This electrode structure may also function as a collision cell in a tandem mass spectrometer.

FIG. 13B is an array of electrode structure cells operating as an all-axis ion guide.

FIGS. 14A and 14B shows the cell electrode structure configured to operate as a single axis RF ion guide for ions moving along the x axis.

FIGS. 15A and 15B shows multiple cell electrode structures in series configured to operate as a single axis RF ion guide or as a mass filter for ions moving along the x axis.

FIG. 15C shows multiple cell electrode structures in series configured to operate as a single axis RF ion guide, or as a mass filter, for ions moving along the x axis with an ion source and detector.

FIG. 15D shows an array of multiple cell electrode structures configured to operate as a multi channel RF ion guide (or as a multi channel mass filter) for ions moving along the z axis.

FIG. 15E shows the array of multiple cell electrode structures from FIG. 15D, but this time configured to operate as a multi channel RF ion guide (or as a multi channel mass filter) for ions moving along the x axis.

FIG. 16 is a schematic showing a quadrupole mass filter mounted on a turntable.

FIGS. 17A through 17J are schematics showing a cell electrode structure configured to operate as an ion trap.

FIGS. 18A through 18H show a cell electrode structure operating as an ion trap, with the electrodynamic quadrupole fields between spheroid electrodes represented as shaded planes.

FIGS. 18I through 18M are schematics depicting a cell electrode structure configured to operate as a trap, with the quadrupole fields between spheroid electrodes represented as shaded planes.

FIG. 19 is a plan view of a micro-bench device.

FIG. 20 is a plan view of a micro-bench device with electrodes and alignment objects assembled on it.

FIG. 21 is a side view of a micro-bench device with electrodes and alignment objects assembled on it.

FIG. 22 is a side view of a fully assembled electrode structure device.

FIG. 23 is a plan and section view of a micro-bench device with multiple sub-mounts for receiving multiple electrodes.

FIG. 24A is a plan and section view of a micro-bench device with multiple electrodes and alignment objects assembled on it.

FIG. 24B is a side view of the fully assembled electrode structure device in FIG. 24A, for multiple electrodes and alignment objects.

FIG. 24C is plan and section view of a multiple channel, multi-electrode structure device.

FIG. 25 is a plan and section view of a multi-electrode structure ion guide device.

FIG. 26 is a plan and section view of another embodiment of a multi-electrode structure ion guide device.

FIG. 27 is a plan and section view of an embodiment of a toroidal multi-electrode structure ion guide device.

FIG. 28 is a plan and section view of another two embodiments of a toroidal or ‘race track’ multi-electrode structure ion guide device.

### DETAILED DESCRIPTION OF THE DRAWINGS

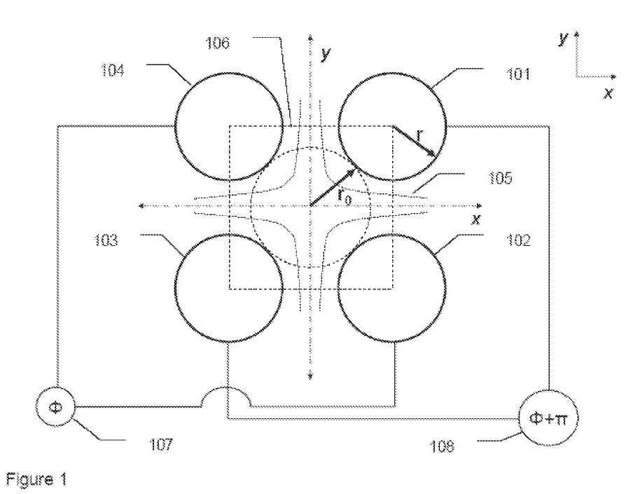

A detailed description of preferred exemplary embodiments of the invention is provided with reference to FIGS. 1 to 28. It will be appreciated that these embodiments are exemplary and are provided to assist in an understanding of the teaching of the present specification but are not to be construed as limiting the invention in any fashion.

FIG. 1 is a cross section in the x-y plane of a quadrupole mass filter. Four circles 102, 102, 103 and 104 represent the four rods of the conventional quadrupole mass filter. The rods are connected to a RF voltage supply 107 and 108, and when the rods are driven by this supply an electrodynamic quadrupole field is generated between the rods. This field represented by the hyperbolic equipotential field lines 105, which is asymptotic to they and x axes at its extremities. The four circles 101, 102, 103 and 104 are tangentially intersected by an inscribed circle with a radius of r₀. In a quadrupole, the centres of the four circles are equidistant and therefore subtend a square 106 between them.

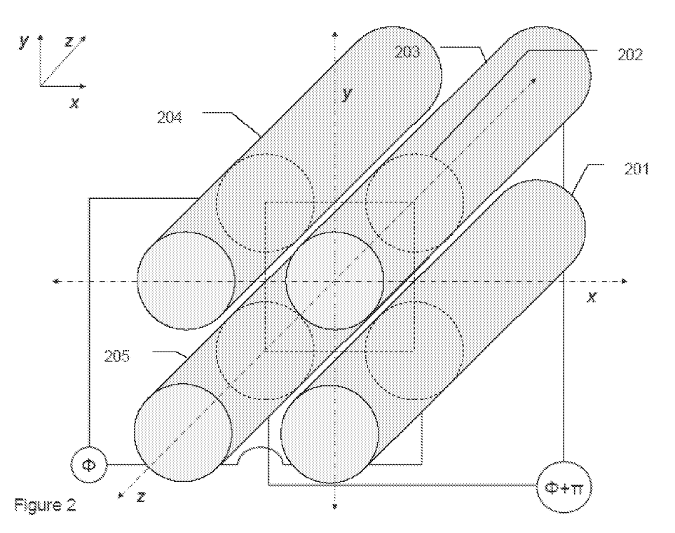

FIG. 2 is a schematic of a quadrupole rod set. The rods 201, 203, 204 and 205 have equidistant centrelines, and their centrelines are parallel with the z axis in this diagram. The cross section of FIG. 1 is superimposed as dashed lines 202, and describes four circles and a square dissecting the rods along the x-y plane. The rods are connect to a RF voltage supply, so that the diagonally opposed pair of rods 203 and 205 are permanently 180 degrees out of phase with the diagonally opposed rod pair 204 and 201.

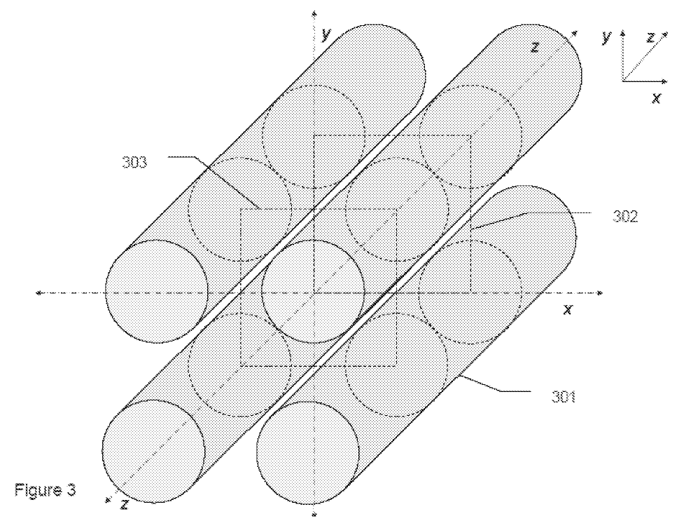

FIG. 3 is a schematic of the same quadrupole rod set shown in FIG. 2, this time with a second cross section 302 taken further down the z axis. The second cross-section may be taken a distance along the z axis equal to the distance along the x or y axis, but orthogonal to the z axis, between the centrelines of two rods. In other words, the second cross-section 302 may be take a distance along the z axis from cross-section 303 that is equal to the length of one side of the square 106 subtended between the centrelines of the four rods. Alternatively, this distance may not be equal to the length of one side of the square 106.

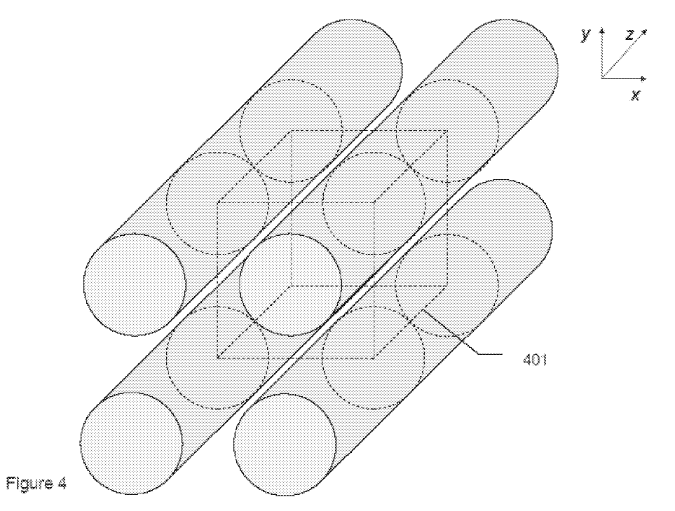

FIG. 4 shows a schematic of the same quadrupole rod set shown in FIGS. 2 and 3, but the two cross-sections are now connected by dashed lines forming cube or cuboid 403. If the distance between the two cross-sections 302 and 303 is equal to one side of square 106, then a cube is generated. Clearly if this distance is not equal to the length of one side of 106, then a cuboid is created.

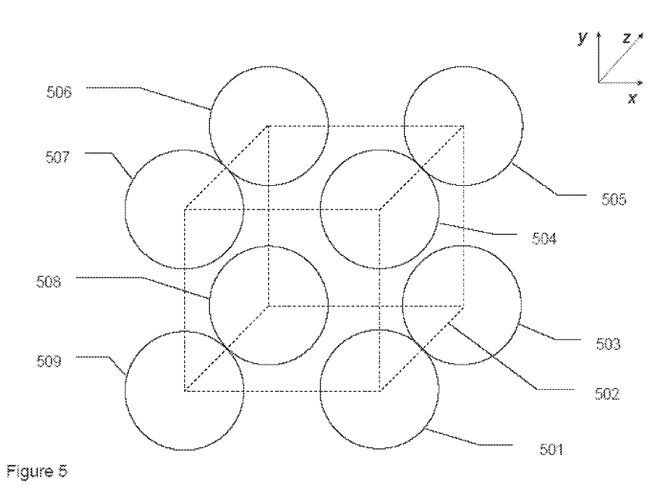

It will be understood that the presentation of the conventional rod structure as provided in FIGS. 1 to 4 was to assist in an understanding of how the geometry of an electrode cell provided in accordance with the teaching of the invention could be usefully generated. FIG. 5 shows the cell structure shown in FIG. 4, with the quadrupole rod set deleted. The cube 502 has eight equal discs 501, 503, 504, 505, 506, 507, 508 and 509 at each of its vertices, each disc representing a rod cross-section. If the rods have hyperbolic, elliptical or parabolic surfaces, then the cross-sections will be hyperbolae, ellipses or parabolas.

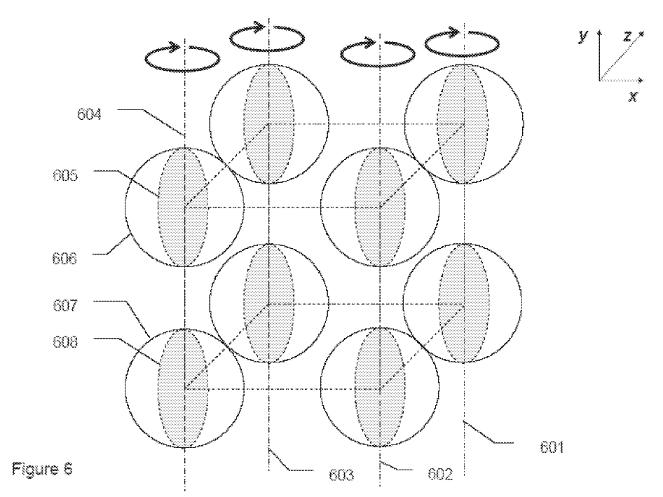

FIG. 6 is the cube of FIG. 5, with four axes 601, 602, 603 and 604 intersecting the centre of discs 501, 503, 504, 505, 506, 507, 508 and 509. If the ellipses defined by the discs are circles, then a rotation of discs 503 and 505 around axis 601, results in a generation of spherical volumes of rotation. Likewise, if discs 605 and 608 are rotated around axis 604, then spheroids 606 and 607 are generated from ellipses, super-ellipses or circles as volumes of rotation. Similarly discs 506 and 508 can be rotated around axis 603, and discs 501 and 504 can be rotated around axis 602. In this way eight spheres are generated at each vertex of the cube (or cuboid) 502. It will be understood that the sphere geometric configuration is a specific example of a spheroid structure that can be usefully employed within the context of the teaching of the present invention.

In this way, if the quadrupole mass filter rods have hyperbolic, elliptical or parabolic surfaces, then the cross-sections will be hyperbolae, super-ellipses, ellipses or parabolas, and hyperboloid, superellipsoid, ellipsoid or paraboloid solids may be generated at each of the vertices of the cube (or cuboid) by similar rotational operations around axes 601, 602, 603 and 604.

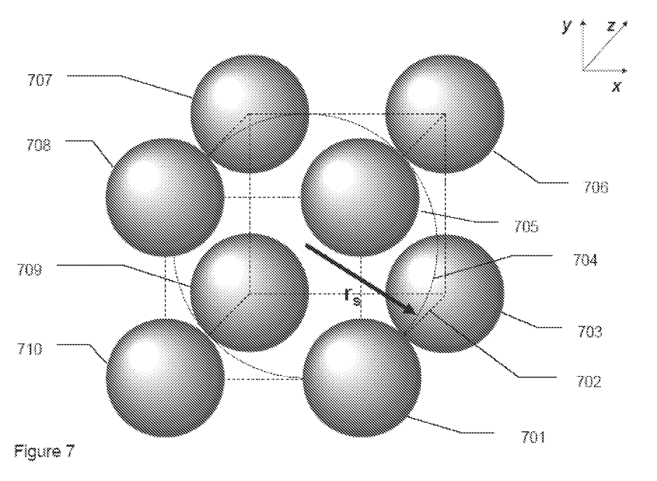

FIG. 7 is a schematic of the solids generated in FIG. 6. Eight sphere electrodes 701, 703, 705, 706, 707, 708, 709 and 710 are found at the vertices of cube 702. A sphere 704 may be inscribed between the spheres, its surface intersecting the surfaces of the sphere electrodes 701, 703, 705, 706, 707, 708, 709 at a tangent.

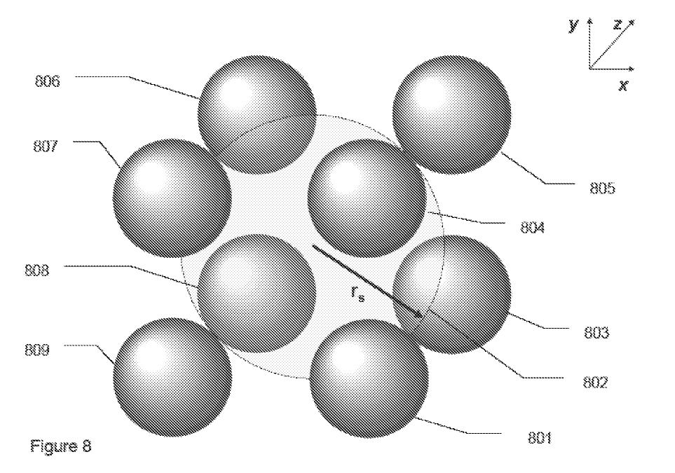

FIG. 8 is a schematic of the sphere (or spheroidal) electrodes 801, 803, 804, 805, 806, 807, 808 and 809, with inscribed sphere 802 shown as a shaded region with a solid radius r_{S}. FIG. 8 is the basic electrode structure of this invention. This arrangement of electrodes can be regarded as a single ‘cell’, module or building block which can be repeated serially and/or in parallel to produce arrays of electrode structures in all directions along the x, y and z axis.

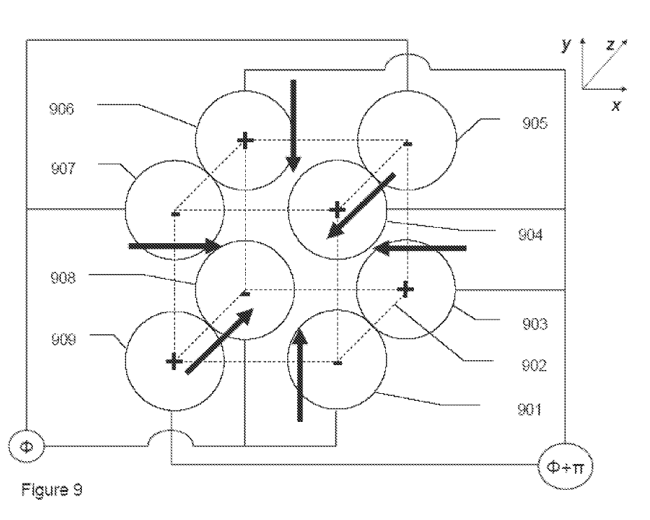

FIG. 9 is a schematic of the electrode structure from FIG. 8, with electrodes 901, 905, 907 and 908 connected to a RF voltage supply which is 180 degrees out of phase with the supply connected to electrodes 903, 904, 906 and 909. The electrodes subtend a cube region 902 between them. Connected like this, at any instant electrodes 901, 903, 908 and 909 form an electric multipole between them. With RF voltage applied in phase to pair 901 and 908, and out of phase to pair 903 and 909, an electrodynamic quadrupole field is formed between electrodes 901, 903, 908 and 909. Likewise electrodes 901, 903, 905 and 904 form another electric multipole; as do electrodes 904, 905, 906 and 907 and 906, 907, 908 and 909. Because of the location of these electrodynamic quadrupole fields across all faces of cube 902, ions approaching the electrode structure along the x, y or z axes are all stable as they enter the cell structure. Arrows represent stable ion trajectories into the electrode structure along the x, y and z axes.

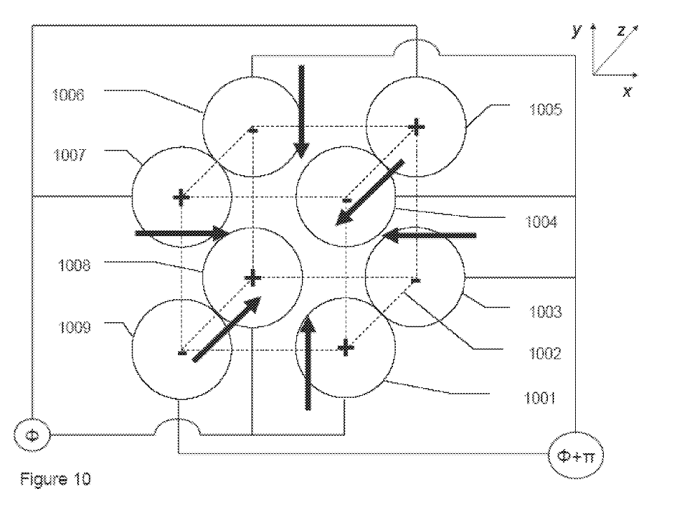

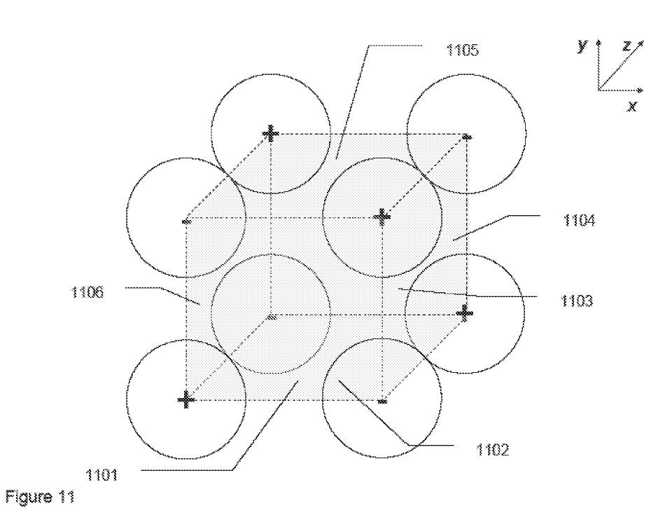

FIG. 10 represents the electrode structure of FIG. 9, but with the polarity of the electrodes reversed by the RF voltage supply. FIG. 11 is a schematic showing the location of the electrodynamic quadrupole fields between the sphere electrodes. Each of the sides of the cube is shown as a shaded plane 1101, 1102, 1103, 1104, 1105 and 1106, and each of these planes represents a quadrupole field. FIG. 12 shows the same fields but with the polarity reversed.

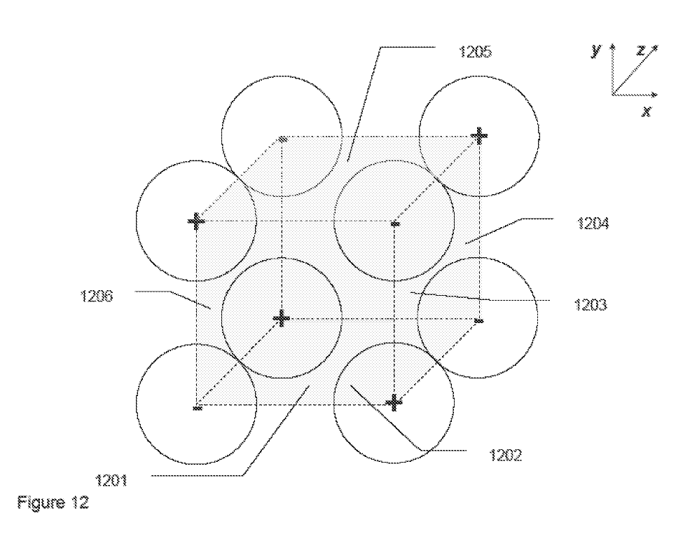

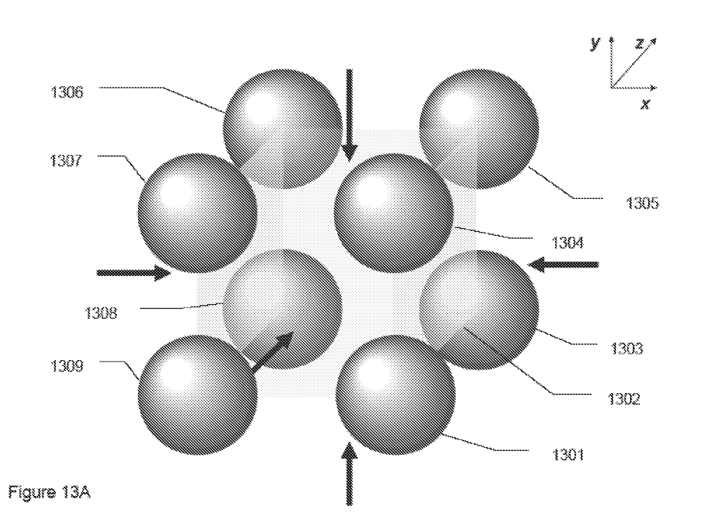

It can be seen in FIG. 13A that when electrically connected as described in FIGS. 9 and 10, the electrode structure functions as an ion guide that permits ions (or charged particles) approaching along the x, y or z axes to simultaneously transfer along stable trajectories between sphere electrodes 1301, 1302, 1303, 1304, 1305, 1306, 1307, 1308 and 1309. The ions so transmitted cross the six quadrupole fields represented by the shaded surfaces of cube (or cuboid) 1302. In this way, the electrode structure functions as an ‘all-axis’ RF ion guide.

In FIG. 13B, a large array of 3×4×4 sphere electrodes is shown. This array is generated by repeating the electrode cell structure described in FIG. 9 through 12 in all directions. Clearly this array can be expanded in all directions by adding identical electrode cells. By connecting the electrode cells as described in FIGS. 9 and 10, the array functions as an ‘all-axis’ ion guide. This array of electrode cells and will transfer ions entering the array orthogonally across the x-y, x-z and y-z planes, along stable trajectories to the opposite site of the array. The arrows represent stable ion trajectories along the x, y and z axes.

Depending on electrical connectivity, individual electrode cells in FIG. 13B may be operated as ion guides, mass filters or ion traps as desired. This array is highly scaleable and may have applications as an (N×M×O) ion ‘cross connect’ in quantum computing, mass spectrometry and charged particle physics.

The ‘all-axis’ ion guide may also function as a collision cell of the kind used in tandem mass spectrometers. The ‘parent’ ions enter along the x axis (for example) from the first-stage quadrupole (or other mass analyser such as time of flight, or trap etc) mass spectrometer stage and are collided with reagent ions entering along the z or y axis, and react with the reagent ions to generate chemically specific ‘product’ ions. The product ions are now transmitted out of the collision cell along the x axis to a second-stage mass analyser for further analysis.

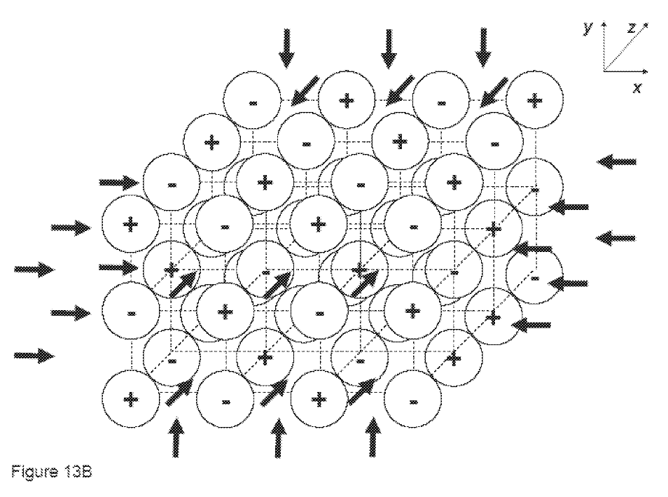

FIGS. 14A and 14B are schematics of an electrode structure (which may be thought of as an individual cell, or ‘building block’ of a larger structure) configured to function as a single axis ion guide, or single axis mass filter. Diagonally opposed pair of electrodes 1407 and 1408, along with second diagonally opposed electrode pair 1403 and 1404, are connected to RF supply 1410. The other two pairs 1401 and 1405, and 1409 and 1406 are connected to RF supply 1411 which may be 180 degrees out of phase with 1410. Connected in this way, as the RF supply alternates the polarity of the electrodes, the electrodes form quadrupole fields between electrodes 1401, 1403, 1404 and 1405, and also between electrodes 1406, 1407, 1408 and 1409. The arrows represent a stable trajectory along the x axis. Equally, ions approaching along the x axis towards the plane between 1406, 1407, 1408 and 1409 are also stable, and will exit between electrodes 1401, 1403, 1404 and 1405.

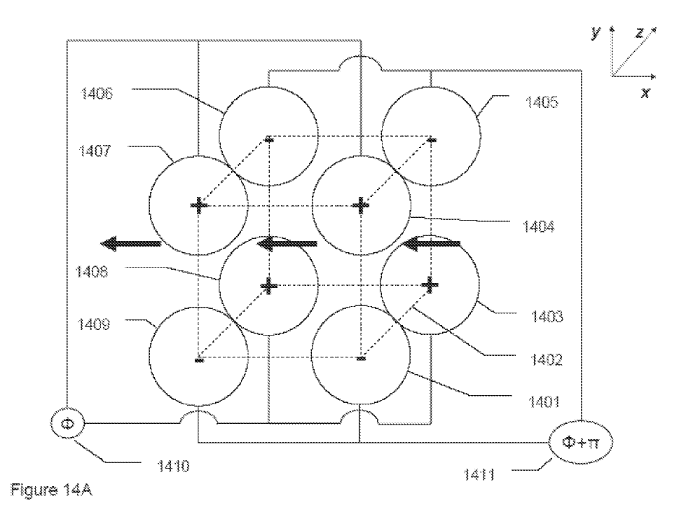

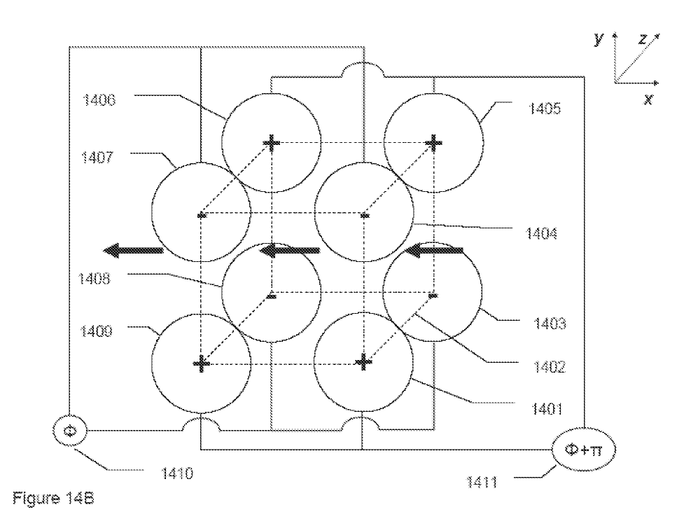

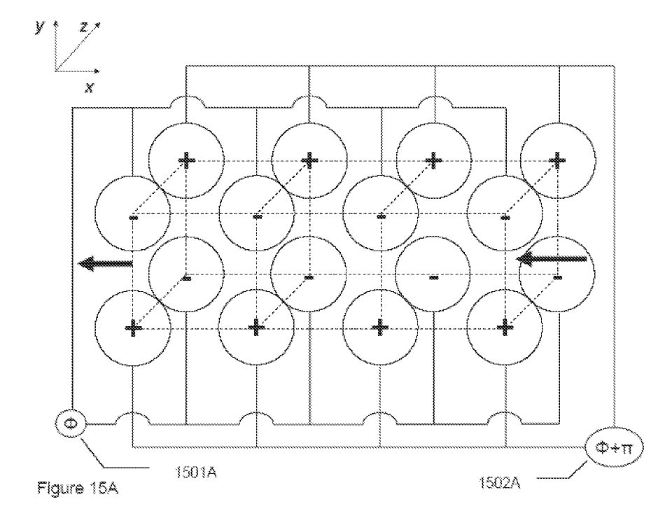

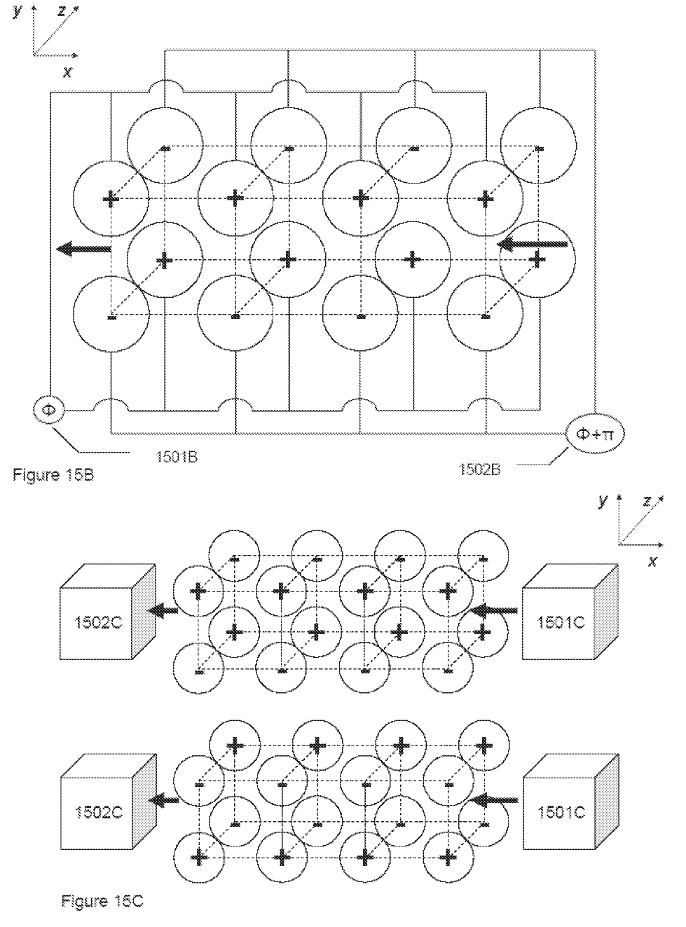

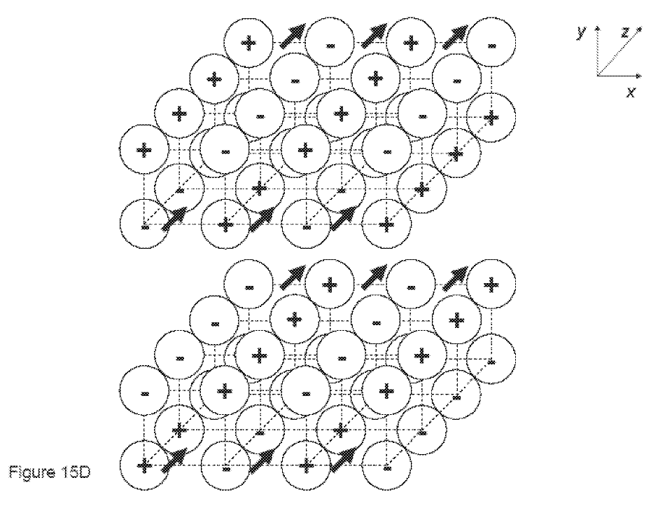

FIGS. 15A and 15B demonstrate how multiple electrode structures cells may be linked together serially and connected to RF voltage supplies 1501A and 1502A. As the polarity is reversed in FIG. 15B by the supplies 1501B and 1502B, the multiple electrode structures form a pseudopotential well between them, and parallel to the x-axis (in this instance). This pseudopotential well forms a RF ion guide so that an ion entering parallel to the x-axis will be transmitted along a stable trajectory to the other end of the guide. This configuration may be operated as a pseudo-quadrupole mass filter by applying a DC ramp to some or all of the electrodes at supplies 1501A and 1502A. By ‘ramping’ the DC voltage applied to the electrodes, one mimic the behaviour of four quadrupole rods, and one can filter ions by mass to charge ratio.

A delayed DC ramp (which has the effect of increasing transmission and resolution) may be obtained by only applying the ramp in DC voltage to the middle and third electrode cells. By applying RF voltage to the first cell, and not to the later cells, this has the effect of delaying the DC ramp until the second and later cells, thereby operating the first cell as a ‘pre-filter’. Similarly, by only applying the DC to the middle cell, one can operate the first and last cells as ‘pre’ and ‘post’ filters respectively.

FIG. 15C is a schematic of the serial electrode structure array operated as a RF ion guide (or as a pseudo quadrupole mass filter) where 1501C is an ion source, and 1502C is an ion detector.

FIG. 15D is a schematic showing an electrode structure array operated as a three channel RF ion guide, or as a 3 channel quadrupole mass filter. In FIG. 15D, the stable ion trajectories are parallel to the z axis, whereas in FIG. 15E the array is electrically reconfigured or ‘switched’ so that there now 4 channels which are parallel to the x axis.

As can be seen, this cellular electrode structure geometry is highly scaleable and versatile, and may be reconfigured to operated in a variety of different modes such as all axis ion guide, single axis ion guide, pseudo quadrupole mass filter and as large, multidimensional arrays of the all the above modes.

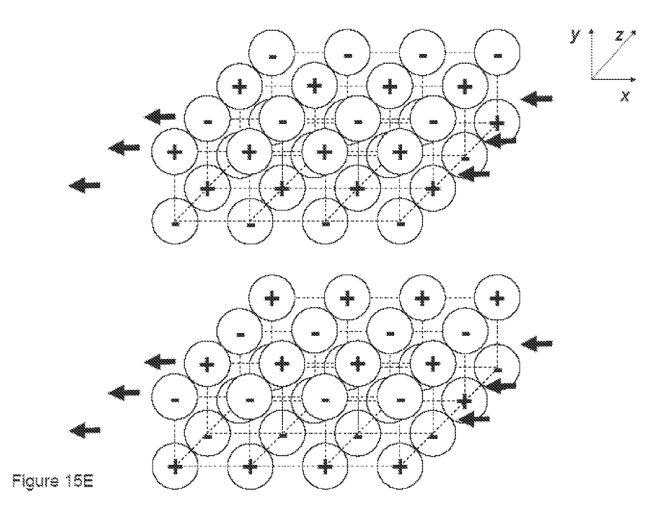

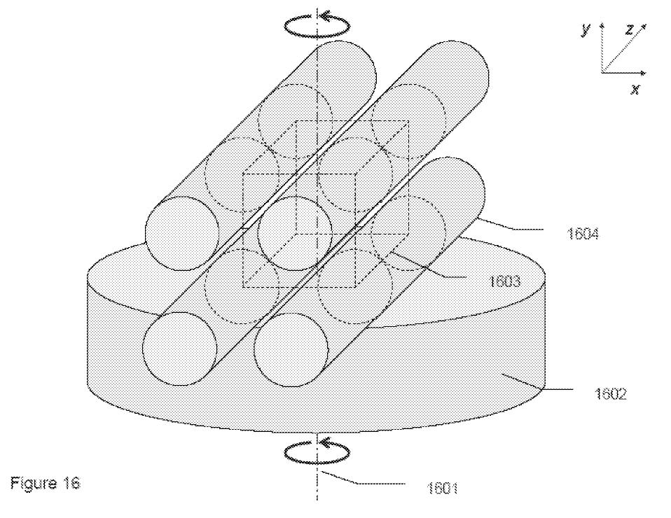

We now turn our attention to operation of the electrode cell structure as an ion trap. FIG. 16 is a schematic of a quadrupole rod set 1604 on its side, placed on a turn-table 1602. The turn-table 1602 rotates around axis 1601 (which is parallel to the y axis as drawn here), this axis 1601 intersecting the centre of cube 1603. An imaginary ion approaches the quadrupole mass filter 1604 along the z axis. Once the ion has entered the quadrupole, and is inside the cube region 1603, the turn-table 1602 may be switched on, spinning the quadrupole 1604 either clockwise or anti-clockwise. The ion is not aware the quadrupole is rotating, but it will ‘see’ the electrodynamic field rotating around it. This will have the effect of trapping the ion within the cube region 1603, and ultimately at a point which is at the intersection of axis 1601 with the axes of symmetry of cube 1603.

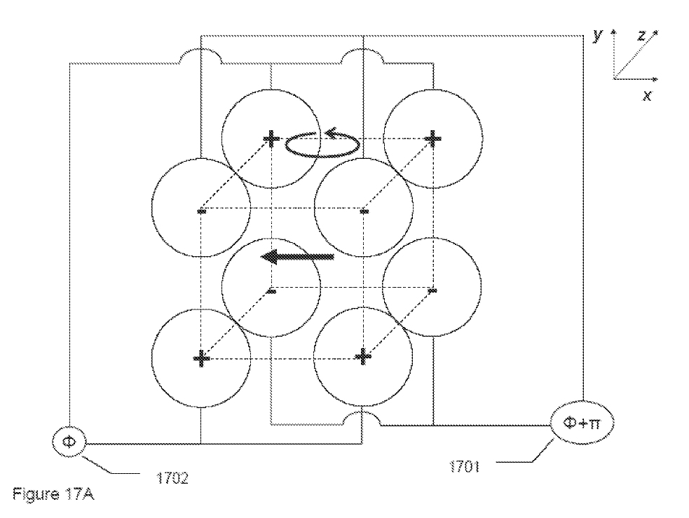

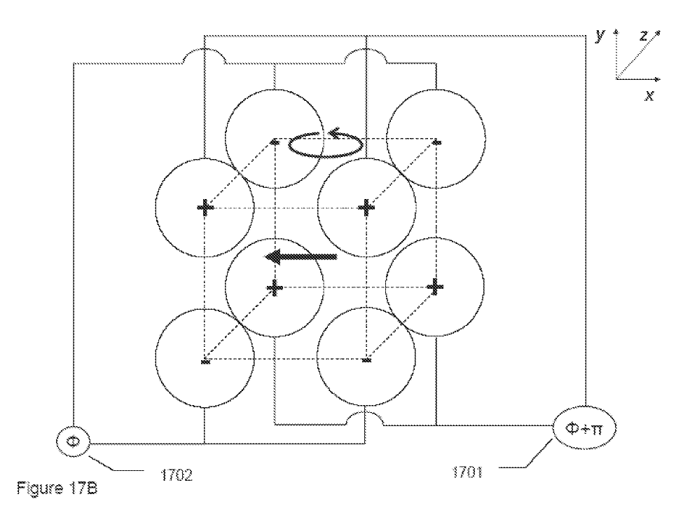

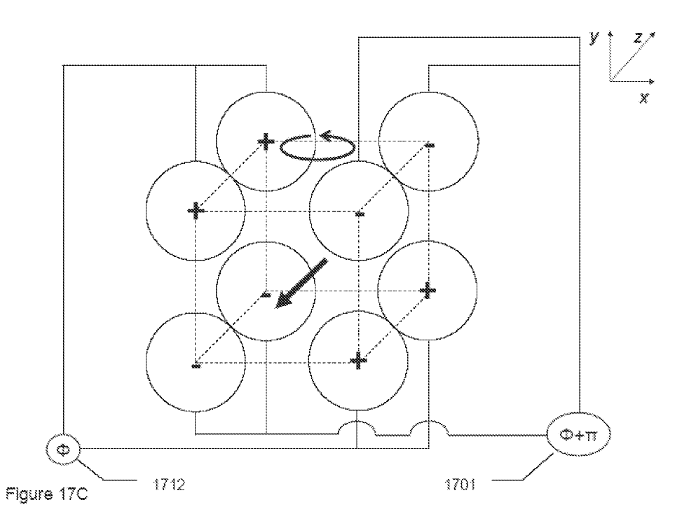

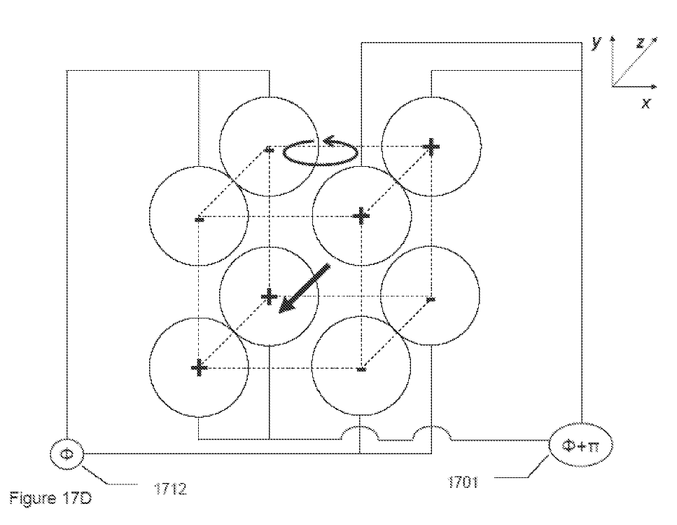

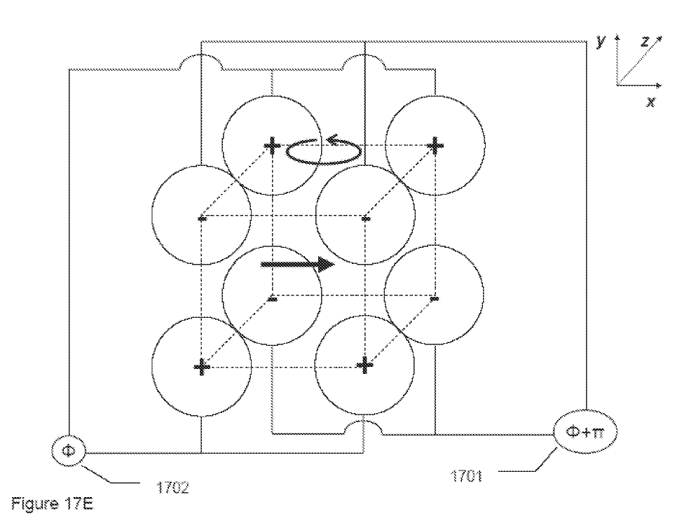

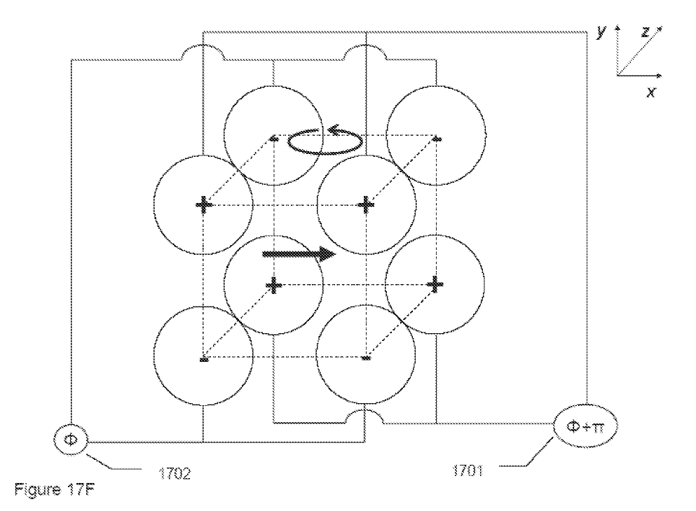

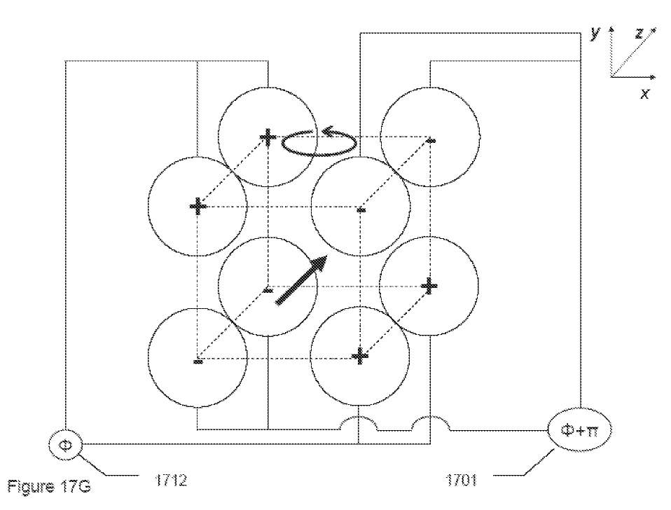

The invention disclosed here is a means of virtually reproducing the rotation of the quadrupole's electrodynamic field around the axes of symmetry of cube (or cuboid) so that an ion (or ions) may be trapped at the point of intersection of these axes. If we now take FIG. 17A, cube region 1603 has eight spheroidal (or hyperboloidal, ellipsoidal or paraboloidal) electrodes at each of its vertices. Two sets of diagonally opposed pairs of these electrodes are connected to RF voltages 1702 and 1701 respectively so that they are 180 degree out of phase. FIG. 17B shows the polarity of the electrodes reversed by the RF supplies 1702 and 1701. The arrow represents an ion's stable trajectory (parallel to the x axis) through the electrode structure.

However, to ‘rotate’ the quadrupole field between the electrodes in the anti-clockwise direction, the electrodes are connected as shown in FIGS. 17C and 17D. Two different sets of diagonally opposed electrode pairs are now connected as shown in 17D to supplies 1712 and 1701. In FIG. 17C the polarity is reversed by supplies 1712 and 1701 so that the arrow represents a stable ion trajectory through the electrode structure such that it is now rotated 90 degrees (so that it is parallel to the z-axis) from the first stable trajectory shown in FIG. 17A and FIG. 17B. In FIGS. 17E and 17F, the electrical connections to the electrodes are again reconfigured such that the ion's stable trajectory has rotated 180 degrees to the trajectory in FIGS. 17A and 17B. The ion's trajectory is now parallel to the x-axis again, but in the opposite direction to its trajectory in 17A and 17B. In FIGS. 17G and 17H, the electrode pairs are again reconnected to supplies 1701 and 1712 in a different configuration such that the ion's trajectory is now rotated 270 degrees from its original trajectory. This process is repeated in FIGS. 17I and 17J such that the ion's trajectory has been rotated a full 360 degrees. By rapidly reconfiguring the connections, or carefully arranging the RF phase, to the electrodes one can rapidly ‘spin’ the quadrupole field and trap an ion near the structures axes of symmetry.

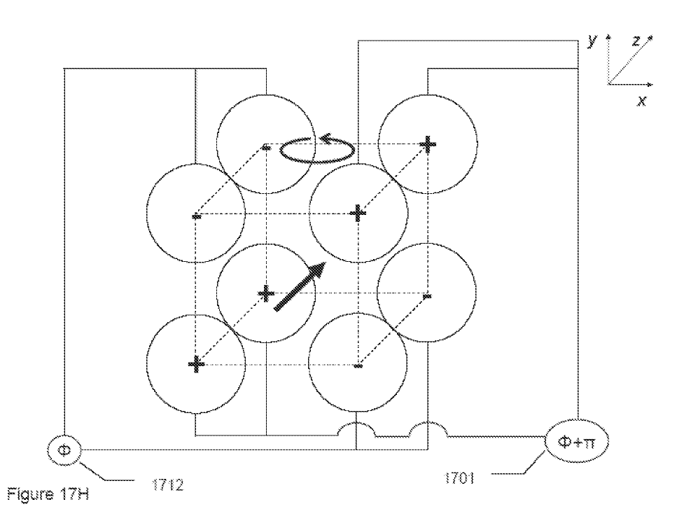

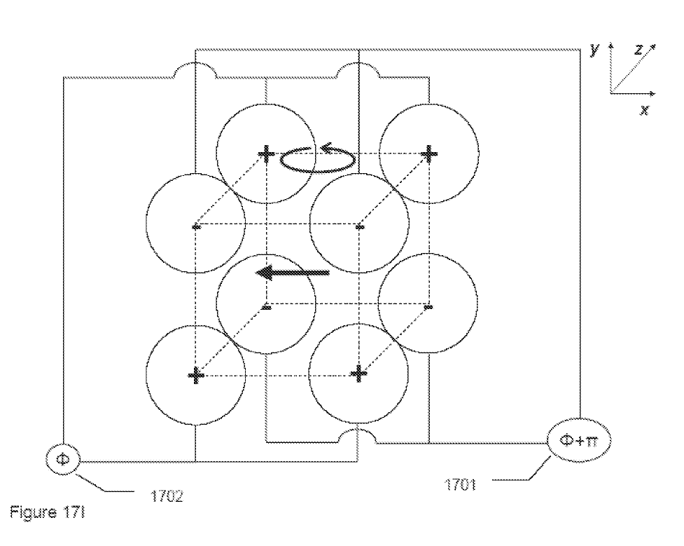

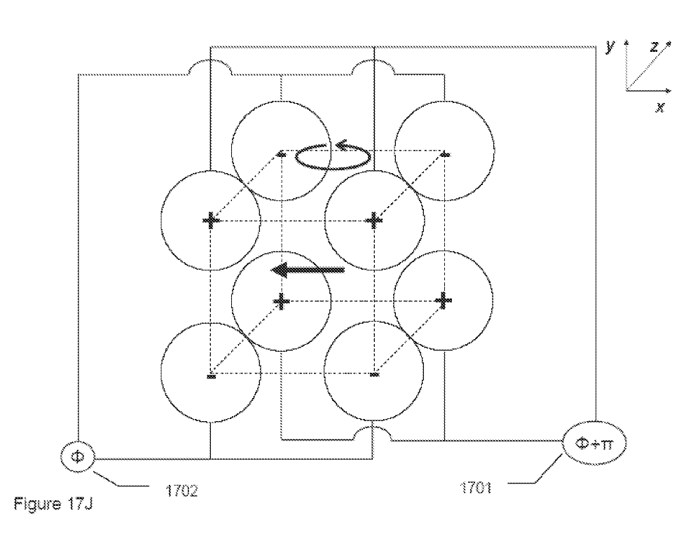

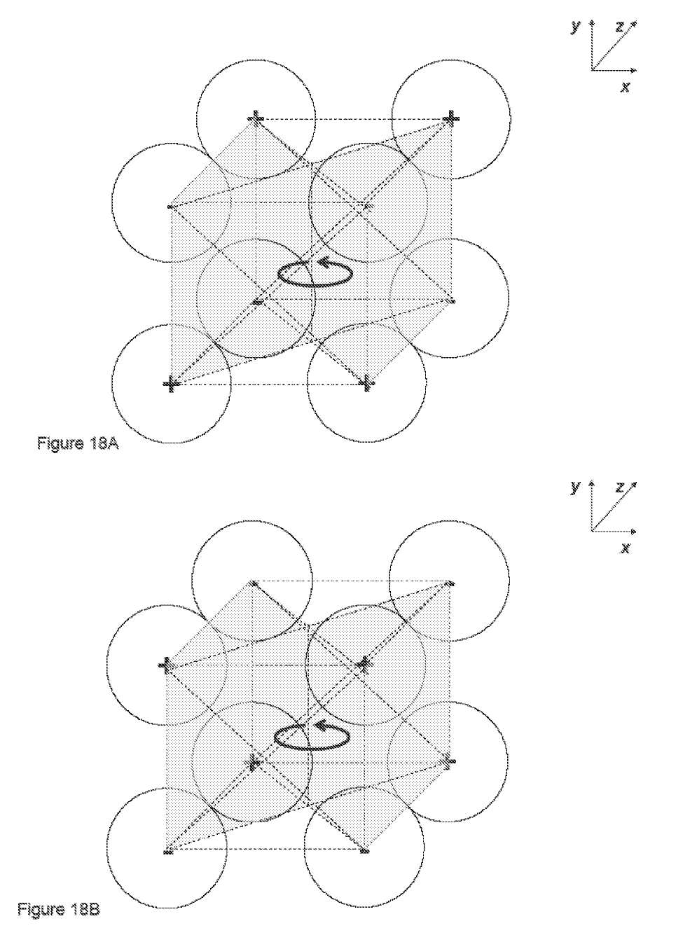

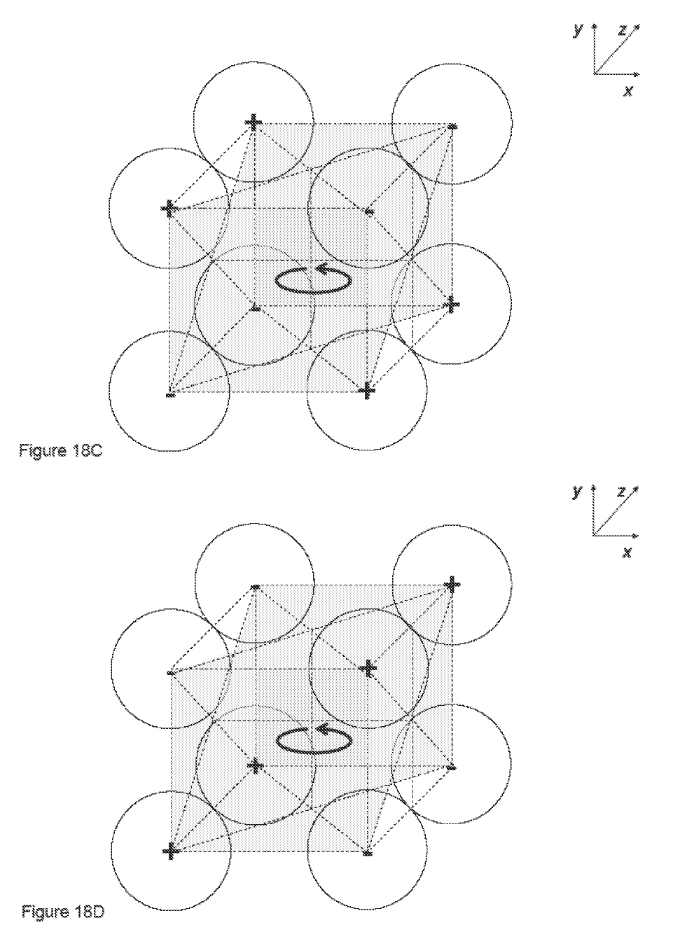

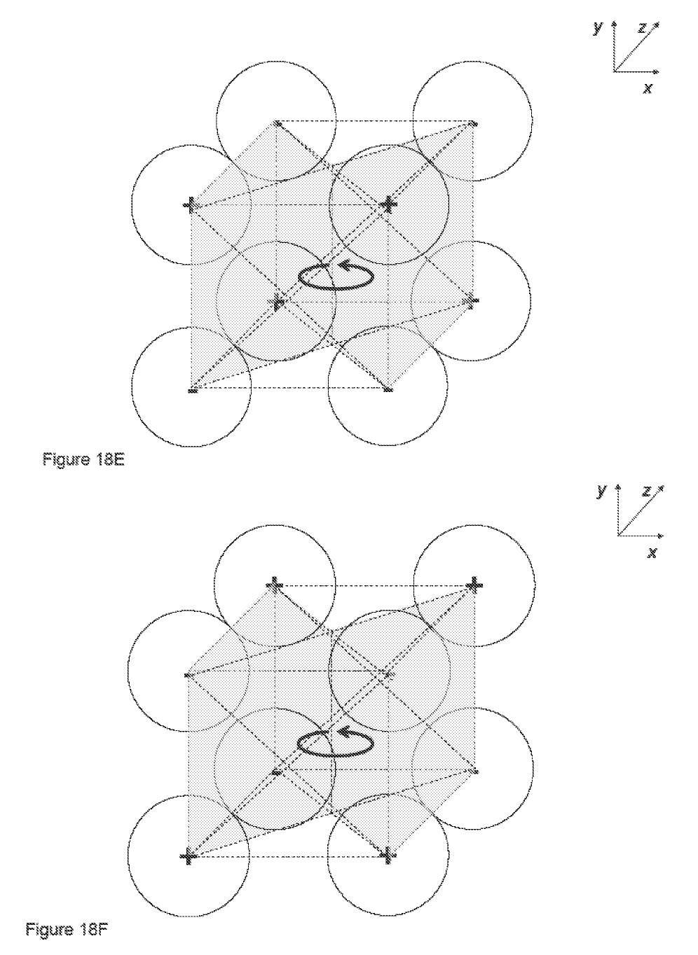

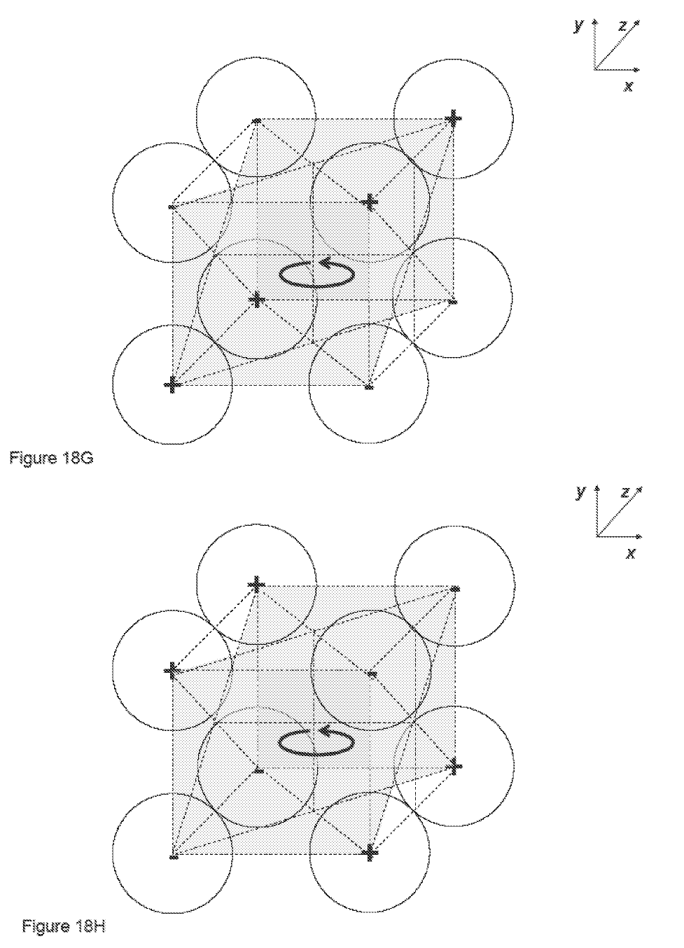

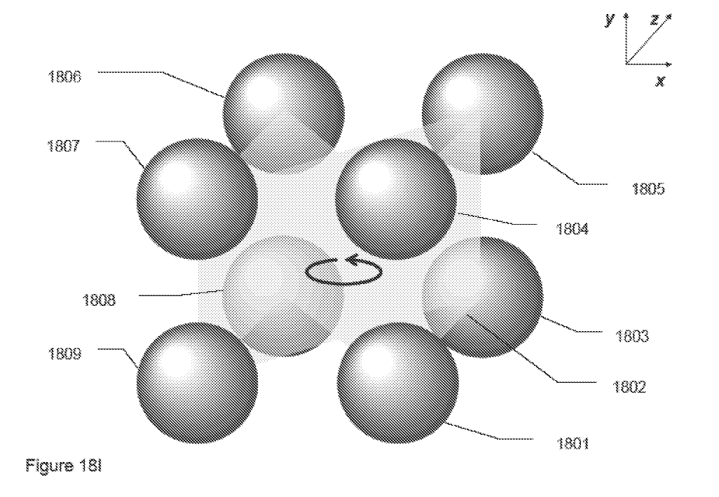

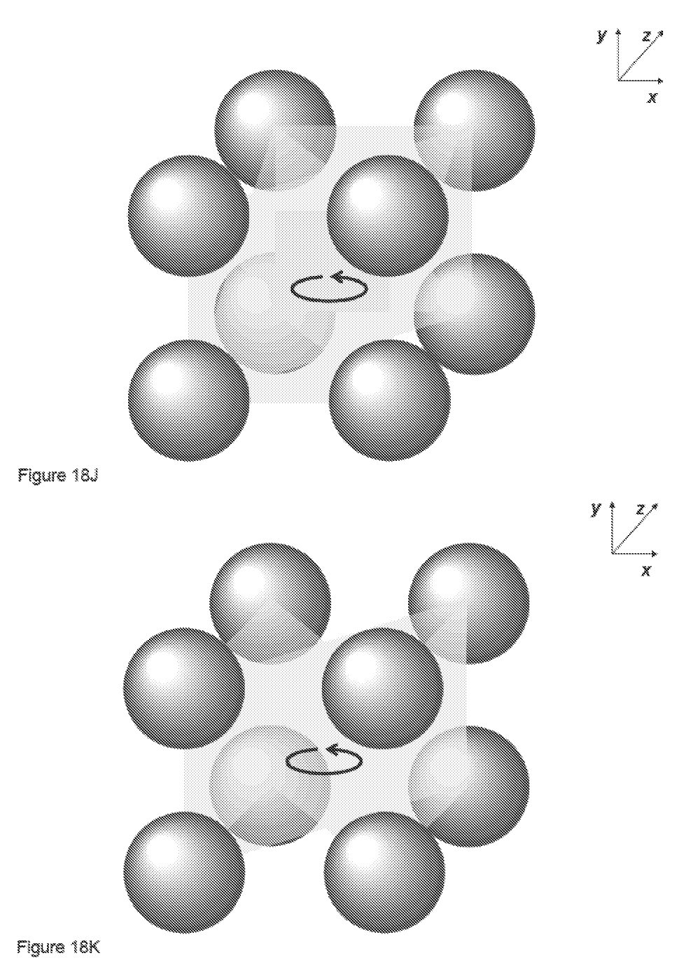

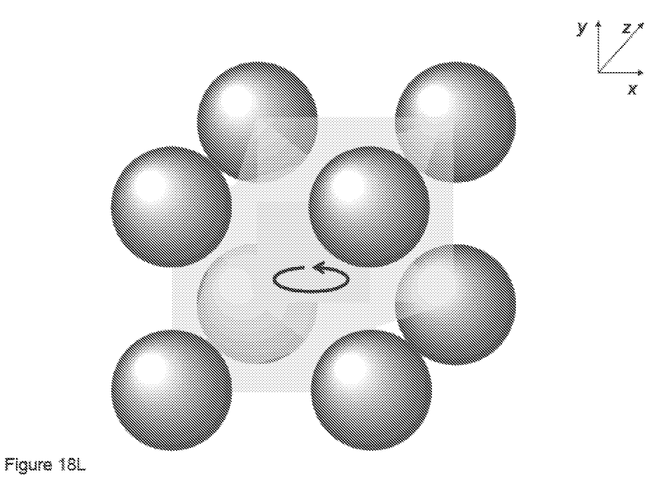

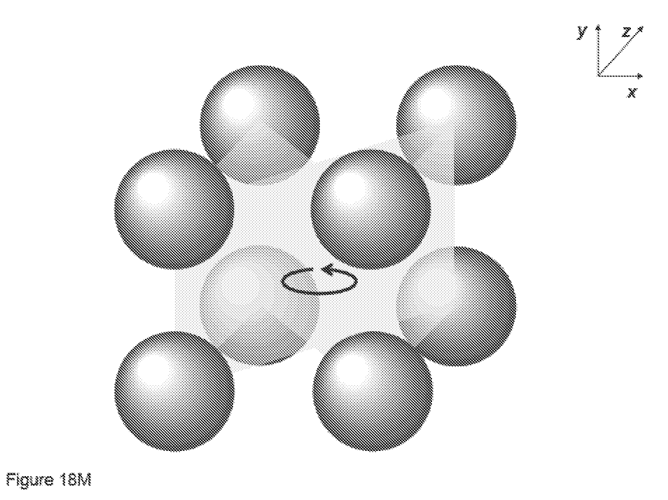

The quadrupole fields may be visualised as planes subtended between two diagonally opposed electrode pairs, where each diagonally opposed electrode pair has opposite polarity to the other pair. In FIG. 18A through FIG. 18H, these fields are represented as shaded planes subtended between electrodes. The intersection of these planes represents a stable, saddle point where an ion may be trapped. In FIGS. 18A through 18H, the planes are rotated by reconfiguration of the RF potentials applied to the electrodes at the extremities of the cube.

Likewise, to aid visualisation, FIGS. 18I through 18M are three dimensional diagrams of the electrode structure of this invention using sphere electrodes, with quadrupole fields represented by shaded planes between the spheres. The locations of these planes rotate as one progresses from FIG. 18I through FIG. 18M, and as the correct sequent of RF voltage is applied to the spheres.

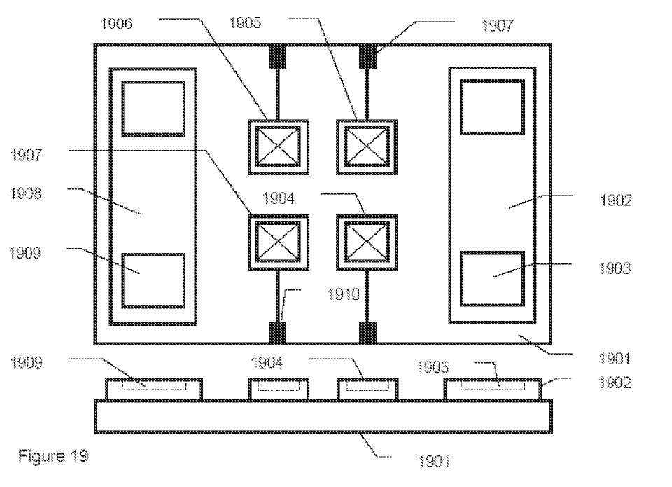

Heretofore the cells or matrices provided in accordance with the teaching of the invention have been described with reference to the geometrical shapes defining the cell and not with reference to physical devices incorporating such geometries. FIG. 19 is included as a plan and side view of a microfabricated device 1901 that may be considered as exemplary of the type of structure that may be fabricated using such geometries. The microfabricated device 1901 may be a substrate with electrically insulating properties. Suitable substrate materials include glass, ceramic, plastic, carbon fibre, metal composite, silicon, other semiconductor materials (e.g. GaAs) and plastic composites and so on. Onto the substrate 1901 are formed submounts. These submounts 1902, 1904, 1905, 1906 and 1907 may be fabricated from suitable conducting materials, semiconducting materials, composite materials or insulating materials with a conductive post processed onto them. The submounts are electrically isolated from each other. The submounts 1905, 1906, 1904 and 1907 need to be electrically addressable, but also electrically separate from each other. This is achieved by mounting the submounts on an electrically insulating substrate 1901, which also serves as a micro-bench to align the submounts to. The submounts 1905, 1906, 1904 and 1907 are designed to receive electrodes and may be electrically contacted through several conductive tracks 1910. All the submounts have alignment features 1909 and 1903 machined into them. These features may be fabricated by means of (bulk or surface micromaching) semiconductor processes such are Deep Reactive Ion Etch (DRIE), Reactive Ion Etch (RIE), wet etching, crystal plane etching (KOH etching along silicon crystal planes), metallisation, sputtering, laser machining and so on. The side view shows the location of the submounts 1902, 1904, 1907 and 1908 relative to each other on micro-bench 1901. The submounts 1902 and 1908 can be seen to have alignment features 1903 and 1909 etched into them, represented by dotted lines. 1904 and 1907 also have alignment features machined into them shown as dotted lines.

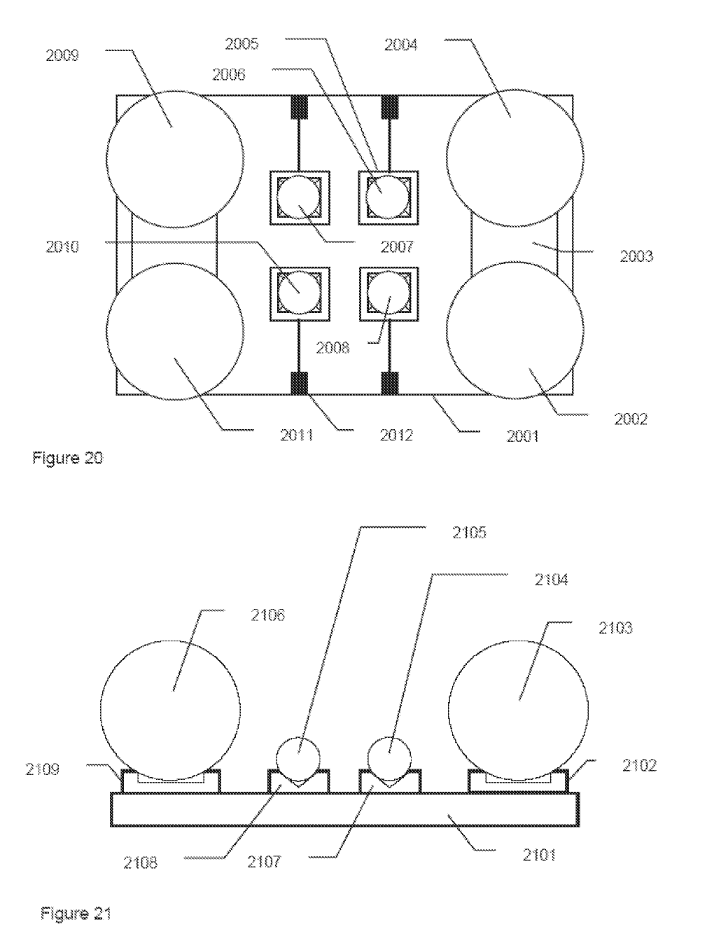

FIG. 20 is a plan view of a microfabricated device 2001, which now has sphere electrodes 2006, 2007, 2008 and 2010 assembled into submounts 2005, 1906, 1907 and 1904. Four kinematic alignment balls 2002, 2004, 2009 and 2011 are mounted in pairs on submounts 2003 and 1908, located by means of etched or micromachined alignment features such as 1903 and 1909. If appropriate micromachining processes such as photolithography are used to locate the submounts 1904, 1905, 1906, 1907, 1902 and 1908, then once assembled the sphere electrodes and kinematic alignment balls should be now perfectly equidistant on micro-bench 2001. A track 2012 contacts electrode 2010 electrically.

FIG. 21 is a side view of the assembled device shown in plan view in FIG. 20. In FIG. 21, the micro-bench may be an insulating substrate 2101 fabricated from some suitable material such as glass, plastic or ceramic (listed in full above). The submounts 2107 and 2108 conductively contact electrodes 2104 and 2105, and are electrically isolated from each other and from submounts 2102 and 2109. Submounts 2102 and 2109 support kinematic alignment balls 2103 and 2106 (the balls may be fabricated from an insulator or from a conductor provided they are electrically isolated) which are electrically isolated from the electrodes 2104 and 2105, and from the micro-bench 2101.

FIG. 22 shows a side view of a fully assembled device supporting the electrode structure of the invention. The device is formed from two well-aligned micro-benches 2201 and 2205; each supporting submounts 2213, 2215, 2205B and 2208. These submounts support for electrodes 2212, 2214, 2207 and 2206. Together, these ball electrodes 2212, 2214, 2207 and 2206 have an inscribed circle with radius r₀. In this way the device, seen from all four side views, looks analogous to a quadrupole mass filter. The two micro-benches are aligned and connected using kinematic ball mounts 2203 and 2209, sited in submounts 2202, 2204, 2210 and 2211. All these submounts are electrically isolated from each other by micro-benches 2201 and 2205. It be noted that a major advantage of this scheme over previously disclosed schemes for aligning and mounting microfabricated quadrupole rods, is that because spheres are used throughout, there is not stress or strain due to mismatches between the coefficient of thermal expansion of the different materials used for 2201, 2202, 2203, 2204, 2205, 2206, 2205B, 2207, 2208, 2212, 2213, 2210, 2209 and 2211. The device described in FIGS. 19 to 22 forms the basic eight electrode cell structure described in FIGS. 6 through 8. Depending on the electrical connectivity of the electrodes, the electrode structure may be operated as ‘all-axis’ ion guides described in FIGS. 9 through 13; or the electrode structure may be operated as an array of ‘all-axis’ ion guides as in FIG. 13B, or may be operated as RF ion guides as described in FIGS. 14A and 14B; or serial electrode structures may be operated as RF ion guides and/or pseudo quadrupole mass filters as described in FIGS. 15A, 15B, 15C and 15D. Finally, the electrode structure microfabricated and assembled as described in FIGS. 19 to 22 forms the basic electrode cell structure and may therefore be operated as the ion trap described in FIGS. 16, 17A to 17J and FIGS. 18A through 18M.

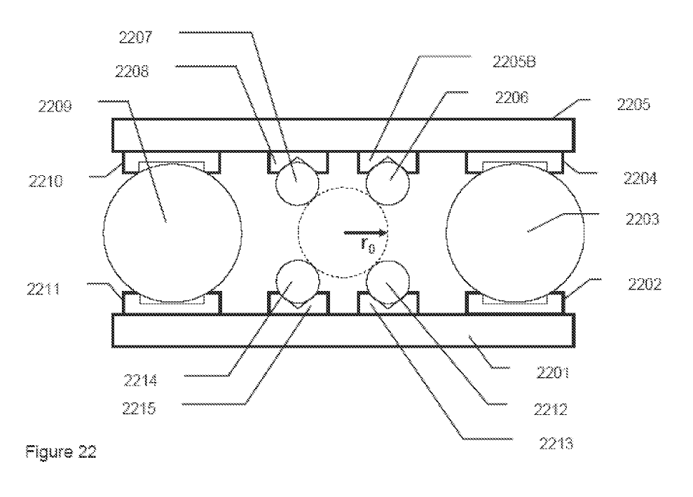

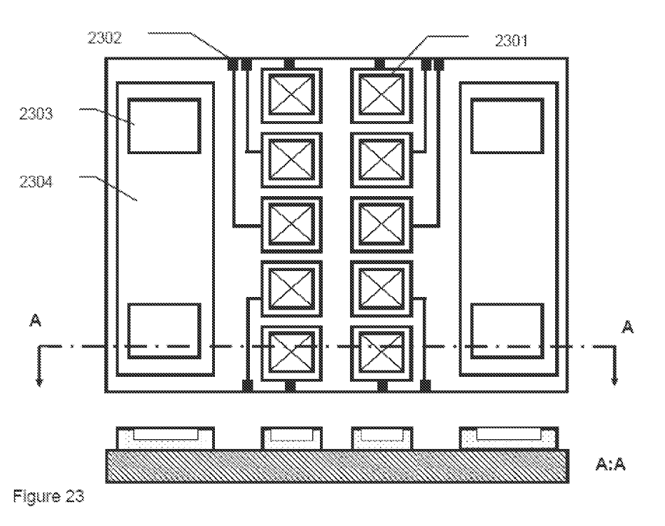

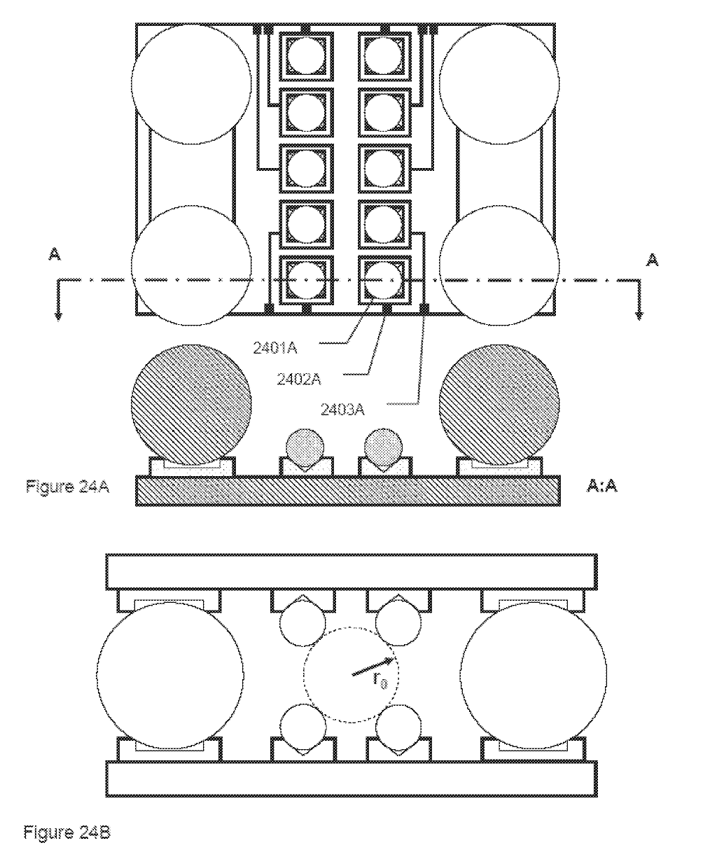

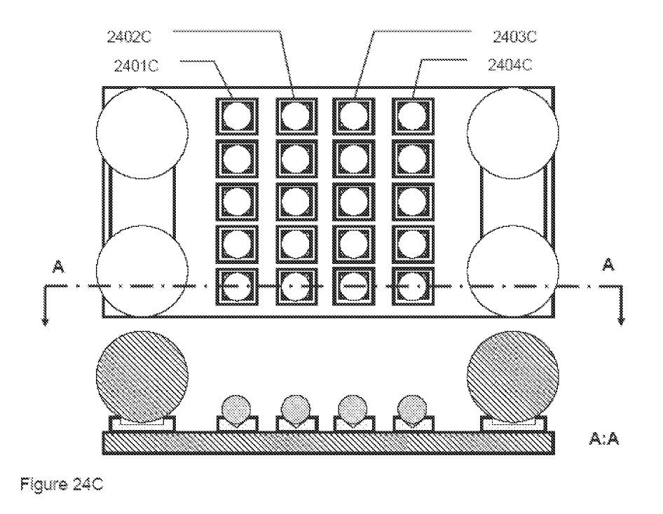

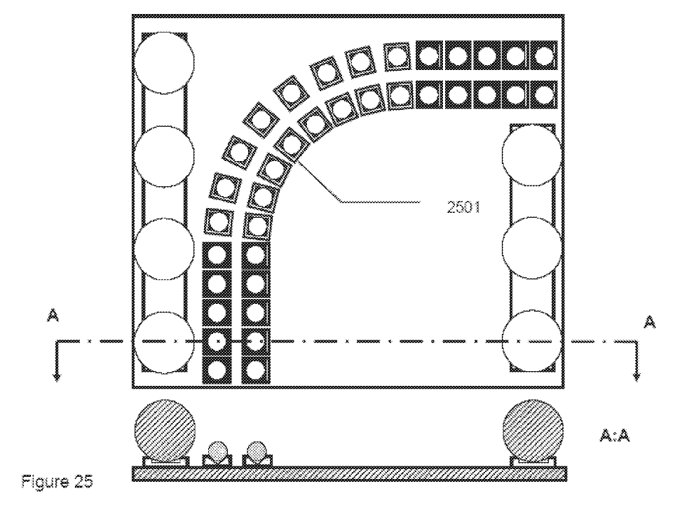

FIG. 23 is a plan and cross section view of an array of submounts such as 2301, mounted on a micro-bench as in FIGS. 19 to 22 above. Submount 2304 has feature 2303 machined into it to alignment, fix and support a kinematic ball mount. The electrode submounts 2301 etc are electrically contacted by means of track 2302. Section A:A shows a cross-section of the micro-bench and its planar submounts, the different materials used being represented by cross hatching or dots. FIG. 24A is a plan and section view showing the same device as in FIG. 23, but with a serial array of sphere electrodes 2401A etc., mounted in electrically conductive submounts 2402A etc., these submounts are electrically addressable by means of tracks 2403A etc. The section A:A shows the kinematic alignments balls, electrode balls, submounts and micro-bench in cross-section. In this way a RF ion guide, or pseudo quadrupole mass filter, as described in FIGS. 15A through 15C may be assembled and connected to an appropriate RF voltage supply. The side view in FIG. 24B shows the aperture of this RF ion guide, or pseudo quadrupole mass filter, with an inscribed radius of r₀ between the electrode spheres, which in turn are aligned between the kinematic alignment balls which may be made from glass, ceramic, composite or metal.

FIG. 24C is a plan and section view of a multiple channel array of RF ion guides or pseudo quadrupole mass filters of the type described in FIGS. 15D and 15E. In this embodiment, there are three channels, but clearly this may be scaled to N channels by adding more electrodes in parallel rows. Four rows of sphere electrodes 2404C, 2403C, 2401C and 2402C shown. Each of the sphere electrodes is fixed and aligned by a submounts placed on a micro-bench fabricated from an insulating substrate, or suitably coated conducting substrate. Clearly, very large arrays of M×N electrodes may be microfabricated and assembled in this way to from the ion ‘cross-connects’ described in FIG. 13B, FIG. 15D and FIG. 15E. Equally, large arrays of ion traps (as described in FIGS. 16, 17A to 17J and FIGS. 18A through 18M) may be configured from the same assemblies of electrodes by electrically contacting the electrodes to different RF voltages using certain sequences of phases.

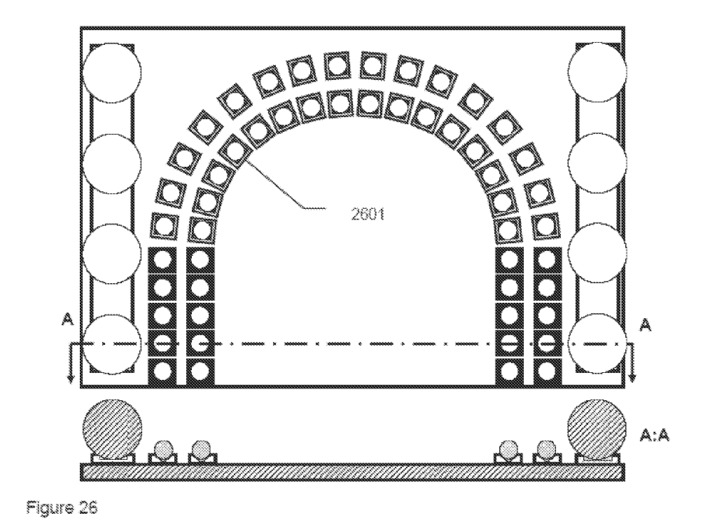

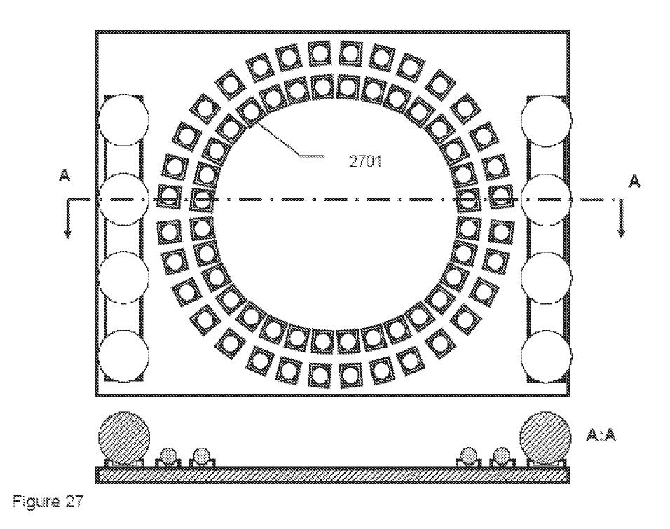

FIG. 25 shows a plan and section view of an ‘arc’ RF ion guide 2501, or mass filter, fabricated on a micro-bench. FIG. 26 shows a plan and section view of a full ‘arc’ RF ion guide 2601 (which may be operated as pseudo mass filters or ion trap arrays or as both) fabricated on a micro-bench.

It will be appreciated by those skilled in the art that the function of an ion guide is to transmit ions along stable trajectories from one point at the entrance of the guide to another point at the exit. The arrangement of electrode structures described for example in FIGS. 25, 26, 27 and 28 may have RF voltages applied to them. In this mode (or “RF only” mode), a pseudopotential well is generated and defined between the electrodes within which ions are stable and will follow the direction of this well. In this way it will be understood that the structures described in FIGS. 25 through 28 may be operated as ion guides to transmit substantially all of the ions at the entrance to the exit. An ion guide of this type will have several applications within a mass spectrometer system.

For example, an RF ion guide may be used as a ‘collision cell’ if placed between two mass analysers inside a tandem mass spectrometer. In the collision cell, ions moving along stable trajectories may be transmitted from the first mass analyser to the second analyser in the tandem mass spectrometer. While inside this ion guide, these ions may be reacted with other ions or neutral species or indeed photons by collision with these particles within the cell.

This collision chamber may be linear or curved or describe an arc and connect two mass analysers. In FIG. 29 a curved or arc-shaped collision cell 2902 based on an array of the electrode structure cells is used as an ion guide between two mass analysers 2901 and 2903 with the advantage that a curved or arced guide will take up less space than a linear cell. In FIG. 29 mass analysers 2901 and 2903 are quadrupole mass analysers, but may be other types of mass analyser such as ion traps, time of flight, linear ion traps and so on. For example, in a curved geometry 2902 between two mass analysers 2901 and 2903, a single turbo pump placed between the mass analyser 2901, the ion guide 2902 and the second mass analyser 2903 could be used to pump all three stages 2901, 2902 and 2903 using one pump.

A further use of an ion guide is to transmit ions from a first vacuum chamber through a second chamber to a third vacuum chamber. If the ion guide is carefully designed, it may be used to focus ions through orifices of progressively smaller diameters through chambers held at progressively lower pressures and in so doing reduce the pumping load on the vacuum system of the mass spectrometer system. If the ion guide is used to transmit ions from a first vacuum chamber through a second chamber to third vacuum chamber, and if the ion guide is operated within a region which is held at a substantially higher pressure than the third chamber, than a phenomenon known as ‘collisional focussing’ may take place. Such focussing permits the formation of a narrow beam of ions, and this beam may be transmitted by the ion guide through a small orifice between the second chamber and the third chamber, and this small orifice may reduce pumping load on the mass spectrometer system's vacuum system.

FIG. 27 shows a plan and section view of a ‘race-track’, torus, tokomak or toroidal RF ion guide 2701 (which may be operated as pseudo mass filters or ion trap arrays or as both) also fabricated on a micro-bench.

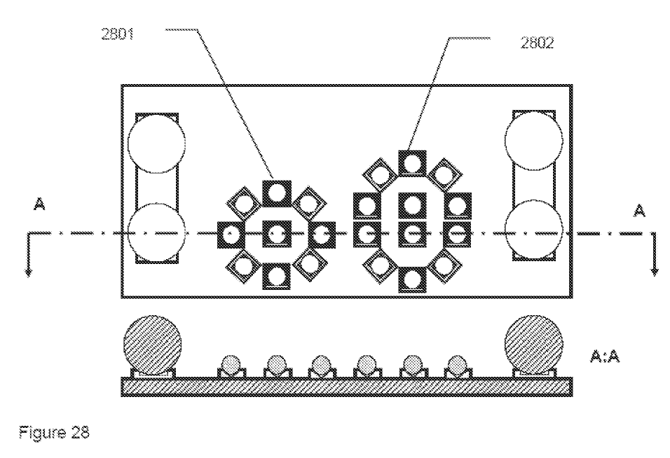

FIG. 28 shows a plan and section view of two different ‘race-track’, torus, tokomak or toroidal RF ion guide geometries 2801 and 2802 (which may be operated as pseudo mass filters or ion trap arrays or as both), also fabricated on a micro-bench.

It will be appreciated that what has been described herein are exemplary arrangements of one or more electrode structures formed from a plurality of individual electrodes, the plurality of electrodes being arranged relative to one another to define a three dimensional geometric structure with individual ones of the plurality of electrodes located at each of the vertices of the geometric structure and wherein each electrode of the cell presents a curved surface to each other electrode of the cell. Such a structure may be configured as a RF ion guide, mass filter or ion trap. Pseudopotential wells formed between the electrodes of the invention may be used to transfer, guide, manipulate, collimate, focus, filter, analyse or trap ions or other charged particles. The electrode structures may be used to efficiently transfers ions from one location to another along pseudopotential field lines generated between the electrodes by applying a RF voltage supply to the electrodes. The ions may exit and enter the cell through spaces defined between the electrodes. The electrode structure of the invention is inherently scaleable and very large arrays of ion guides, ion traps and mass filters may be constructed. In some embodiments an array of electrode structures may be operated as an ion or charged particle ‘cross-connect’ switch, to guide and redirect ions along orthogonal axes. Applications of the invention may include particle physics, quantum computing and mass spectrometry. While the teaching of the present specification has been explained with reference to exemplary arrangements herein it will be understood that modifications can be made without departing from the spirit and or scope of the present invention. Integers or components that are described with reference to any one Figure could be interchanged or replaced with those of another Figure without departing from the present teaching.

It will be understood that while the cells or matrix structures described herein have not been delimited by dimension that such cells or matrix structures particularly lend themselves to being fabricated as a microengineered or microfabricated structure. Within the context of the present invention the term microengineered or microengineering or microfabricated or microfabrication is intended to define the fabrication of three dimensional structures and devices with dimensions in the order of microns. It combines the technologies of microelectronics and micromachining. Microelectronics allows the fabrication of integrated circuits from silicon wafers whereas micromachining is the production of three-dimensional structures, primarily from silicon wafers. This may be achieved by removal of material from the wafer or addition of material on or in the wafer. The attractions of microengineering may be summarised as batch fabrication of devices leading to reduced production costs, miniaturisation resulting in materials savings, miniaturisation resulting in faster response times and reduced device invasiveness. Wide varieties of techniques exist for the microengineering of wafers, and will be well known to the person skilled in the art. The techniques may be divided into those related to the removal of material and those pertaining to the deposition or addition of material to the wafer. Examples of the former include:
Wet chemical etching (anisotropic and isotropic)
Electrochemical or photo assisted electrochemical etching
Dry plasma or reactive ion etching
Ion beam milling
Laser machining
Excimer laser machining

Whereas examples of the latter include:
Evaporation
Thick film deposition
Sputtering
Electroplating
Electroforming
Moulding
Chemical vapour deposition (CVD)
Epitaxy

These techniques can be combined with wafer bonding to produce complex three-dimensional, examples of which are the cells provided by the present invention.

Where the words “upper”, “lower”, “top”, bottom, “interior”, “exterior” and the like have been used, it will be understood that these are used to convey the mutual arrangement of the layers relative to one another and are not to be interpreted as limiting the invention to such a configuration where for example a surface designated a top surface is not above a surface designated a lower surface.

The words comprises/comprising when used in this specification are to specify the presence of stated features, integers, steps or components but does not preclude the presence or addition of one or more other features, integers, steps, components or groups thereof.

1. An electrode cell formed from a plurality of individual electrodes, the individual electrodes being provided on separate submounts, the submounts being kinematically coupled to one another using kinematic ball mounts.

2. The cell of claim 1 wherein the kinematic ball mounts are located by means of a micromachined alignment feature on respective submounts.

3. The cell of claim 1 wherein the kinematic ball mounts are electrically isolated from the electrodes.

4. The cell of claim 3 wherein the kinematic ball mounts are fabricated from an insulator.

5. The cell of claim 3 wherein the kinematic ball mounts are fabricated from a conductor which is electrically isolated from the electrodes.

6. The cell of claim 3 wherein balls of the kinematic ball mounts are made from glass, ceramic, composite or metal.

7. The cell of claim 1 wherein the kinematic ball mounts concurrently align and connect the submounts.

8. The cell of claim 1 wherein a submount has a feature machined into it to alignment, fix and support a kinematic ball mount.

9. The cell of claim 1 wherein the electrodes are aligned between the kinematic ball mounts.

10. The cell of claim 9 wherein the balls of the kinematic ball mounts have a greater radius than the radius of the electrodes.

11. The cell of claim 1 comprising first and second kinematic ball mounts.

12. The cell of claim 1 comprising four kinematic ball mounts.

13. The cell of claim 1 wherein the electrodes are solid electrodes or have an insulating core with a conducting surface thereon.

14. The cell of claim 1 including a voltage generator operably providing a voltage of a predefined frequency to selected ones of the plurality of electrodes, the voltage generator typically providing an AC voltage and optionally being operable in a switch mode configuration.

15. The cell of claim 14 wherein the individual electrodes are substantially identical such that the field lines that are generated by each of the electrodes will be substantially equal.

16. The cell of claim 1 being operable to effect generation of a pseudopotential well which may be used to filter, trap or guide ions or other charged particles.

17. A mass filter or ion guide or ion trap including one or more cells as claimed in claim 1.

18. A microfabricated device having a first and second insulating substrate each having a plurality of submounts provided thereon and wherein individual submounts are individually electrically addressable and provide a support for an electrode, and wherein the submounts are located relative to one another on their respective substrate such that when the two substrates are brought together in a sandwich structure, kinematic ball mounts concurrently align and connect the two substrates.

19. A microfabricated device comprising a first and second substrate, each substrate supporting individual electrodes which are electrically addressable, the substrates further comprising kinematic ball mounts arranged such that when the two substrates are brought together in a sandwich structure, the kinematic ball mounts concurrently align and connect the two substrates.
